(19) United States
(12) Patent Application Publication
(10) Pub. No.: US 2020/0361676 A1
(43) Pub. Date: Nov. 19, 2020

(54) CONTAINER APPARATUS, METHODS FOR OPENING CONTAINERS AND ZIPPER MEMBER FOR A CONTAINER APPARATUS

(71) Applicant: CSP TECHNOLOGIES, INC., Auburn, AL (US)

(72) Inventors: Hank Womble, Auburn, AL (US); Trevor Johnson, Auburn, AL (US); Jean-Pierre Giraud, Auburn, AL (US); Franklin Lee Lucas, Jr., Auburn, AL (US); Ethan Ross Perdue, Auburn, AL (US); Brian Tifft, Auburn, AL (US); Kasey Myers, Auburn, AL (US)

(21) Appl. No.: 16/762,825

(22) PCT Filed: Nov. 9, 2018
(86) PCT No.: PCT/US2018/059989

§ 371 Date: May 8, 2020

Related U.S. Application Data
(60) Provisional application No. 62/583,611, filed on Nov. 9, 2017.

(51) Int. Cl. B65D 50/06; A61J 1/03; A61J 1/14

(52) U.S. Cl. CPC B65D 50/065; A61J 1/03; B65D 50/067; B65D 50/062; A61J 1/1437

(57) ABSTRACT

Container apparatus embodiments for providing preferably child resistant and senior friendly closures are provided. Generally, the embodiments include containers, each having an internal product space configured for housing at least one product. Generally, the container apparatus embodiments are each configured to move between a CLOSED position and an OPENED position. Various mechanisms according to the disclosed concepts are described to help prevent a person who should not be accessing contents of the container apparatus from doing so.

### FIELD OF THE DISCLOSED CONCEPT

The disclosed concept relates to container apparatus such as, for example, container apparatus used to store medical tablets and the like. The disclosed concept also relates to methods for opening containers.

### BACKGROUND

There is an increasing awareness of the need to protect children from inadvertently gaining access to medications and other potentially harmful products. Ingestion of only one or two pills of a prescribed medication can prove fatal to a child. There is a further increasing awareness of the necessity to provide containers that are readily and easily opened by an adult, that is, any person having the cognitive ability to understand the instructions for opening a container, which requires certain manipulation and manual dexterity. Such persons are assumed to have the ability to understand that the act of opening such a container to gain access to the contents is a deliberate action, and is only undertaken when there is a necessity to attain access to such contents.

There are several conventional, so-called, “childproof” or “child-resistant” containers in the market, which are generally employed by dispensing pharmacists for use in filling prescriptions, where the prescription requires that the pharmacist dispense one or more of a plurality of pills, tablets, gel-caps, capsules, or the like. For example, the container may include a “push-and-tum” closure for pill containers, or an “arrow-alignment” closure for pill containers.

The “push-and-tum” system for containers conventionally refers to a system in which the closure or cap for the container must be pushed axially downwardly and rotated at the same time to open the container. The “arrow alignment” system for containers conventionally refers to a system in which an arrow on the closure or cap must be aligned with an arrow on the container, such as one which is embossed on the container, in order to open the container. However, these containers can be complicated or difficult for some adults to use, especially adults with sub-optimal manual dexterity.

Conventional container apparatus of the type where the cap or closure is integral with the container may include a hinge that pivotally affixes the cap and the container, and in some cases have a fixed protrusion (also referred to as a “thumb tab”) attached to the cap that is configured to assist in the opening of the cap. This fixed protrusion is typically opposite the hinge, and thus acts as a lever to allow the intended user to open the container when a sufficient force is applied under the fixed protrusion. Such containers can often easily be opened by children.

### SUMMARY OF THE DISCLOSED CONCEPTS

As one optional aspect of the disclosed concept, a container apparatus is provided that comprises a body having a base and a sidewall extending therefrom. The body defines an interior comprising a product space configured for housing at least one product. The body further has an opening leading to the interior. The container apparatus further comprises a lid configured to be attached to the sidewall via a hinge, and a trigger member connected to or integral with the hinge, the trigger member having a distal portion disposed opposite the hinge and external with respect to the interior. The container apparatus is structured to move between a CLOSED position corresponding to the lid covering the opening, and an OPENED position wherein the lid does not cover the opening. When the container apparatus moves from the CLOSED position toward the OPENED position, the distal portion initially moves toward the interior.

As another optional aspect of the disclosed concept, a method of opening a container is provided that comprises the steps of providing the container with a body and a lid, the body having a base and a sidewall extending therefrom, the body defining an interior comprising a product space configured for housing at least one product, the body further having an opening leading to the interior, the lid being configured to be attached to the sidewall via a hinge; providing the sidewall with a top portion and a number of latching members extending therefrom; providing the lid with a body portion and a number of latching members extending therefrom, each of the latching members of the lid being interlocked with a corresponding one of the latching members of the sidewall, the body portion of the lid having a number of thru holes each proximate a corresponding one of the latching members of the lid; providing a tool comprising a gripping portion and a number of protrusions extending therefrom; inserting each of the number of protrusions of the tool through a corresponding one of the thru holes in order to release the latching members of the lid from the latching members of the sidewall; and pivoting the tool about the hinge in order to open the container.

As another optional aspect of the disclosed concept, a container apparatus is provided that comprises a body having a base and a sidewall extending therefrom, the body defining an interior comprising a product space configured for housing at least one product, the body further having an opening leading to the interior; a lid configured to be attached to the sidewall via a hinge, the lid being structured to move between a CLOSED position corresponding to the lid covering the opening and an OPENED position wherein the lid does not cover the opening; and a member comprising a coupling portion and a securing portion connected to the coupling potion, the coupling portion being coupled to the sidewall, the member being structured to move between a FIRST position corresponding to the securing portion engaging the lid in order to maintain the lid in the CLOSED position, and a SECOND position wherein the securing portion does not engage the lid. When the member moves from the FIRST position toward the SECOND position, the securing portion revolves around a top portion of the sidewall in order to allow the lid to move from the CLOSED position to the OPENED position.

As another optional aspect of the disclosed concept, a container apparatus is provided that comprises a body having a base, a sidewall extending from the base, and a member, the body defining an interior comprising a product space configured for housing at least one product, the body further having an opening leading to the interior, the member being disposed opposite the base and extending from the sidewall away from the interior; and a lid configured to be attached to the sidewall via a hinge, the lid comprising a cover portion structured to cover the opening, a protrusion extending outwardly from the cover portion, and a component connected to the cover portion, the lid being structured to move between a FIRST position corresponding to the cover portion covering the opening, and a SECOND position wherein the cover portion does not cover the opening. When the lid is in the FIRST position, the protrusion engages the member in order to maintain the lid in the FIRST position. When the lid moves from the FIRST position toward the SECOND position, the component moves into engagement with the member in order to disengage the protrusion from the member.

As another optional aspect of the disclosed concept, a zipper member for a container apparatus is provided. The container apparatus comprises a bag having a first end portion and a second end portion, the bag being structured to move between a FIRST position corresponding to the first end portion being interlocked with the second end portion, and a SECOND position corresponding to the first end portion being spaced from the second end portion. The zipper member comprises a body structured to be coupled to the first end portion and the second end portion; a pair of opposing arms extending from the body, the pair of opposing arms being structured to move between a THIRD position corresponding to disengagement with the first end portion and the second end portion, and a FOURTH position corresponding to engagement with the first end portion and the second end portion; and a hood extending from the body, the hood being structured to move between a FIFTH position corresponding to disengagement with the pair of opposing arms, and a SIXTH position corresponding to engagement with the pair of opposing arms. When the hood is in the SIXTH position, the hood extends between the pair of opposing arms in order to maintain the pair of opposing arms in the THIRD position.

### BRIEF DESCRIPTION OF THE DRAWINGS

Exemplary embodiments of the present disclosed concept are shown in the enclosed drawings as follows:

FIGS. 1-4 are different views of a container apparatus, in accordance with one non-limiting embodiment of the disclosed concept;

FIGS. 5 and 6 are isometric and top views, respectively, of a trigger member for the container apparatus of FIGS. 1-4;

FIG. 7 is a section view of the container apparatus of FIGS. 1-4, shown in the OPENED position and shown without the trigger member;

FIG. 8 is a side elevation view of the container apparatus of FIGS. 1-4, shown with the trigger member partially installed on the body of the container apparatus;

FIG. 9 is a section view of the container apparatus of FIG. 1, taken along line A-A of FIG. 1, and shown with a hook portion of the trigger member extending into a grooved region of the lid;

FIG. 10 is an enlarged view of a portion of the container apparatus of FIG. 9;

FIG. 11 is another enlarged view of the container apparatus of FIG. 9, shown with the hook portion not extending into the grooved region;

FIG. 12 is another enlarged view of the container apparatus of FIG. 9, shown with the lid in an OPENED position;

FIG. 13 is an isometric view of the container apparatus of FIG. 12;

FIGS. 14 and 15 are respectively rear and front isometric views of another container apparatus, in accordance with another non-limiting embodiment of the disclosed concept;

FIG. 16 is an enlarged view of a portion of the container apparatus of FIG. 15;

FIG. 17 is another enlarged view of the portion of the container apparatus of FIG. 15, shown with an elongated member of the lid moved toward the interior of the body of the container apparatus;

FIG. 18 is another isometric view of the container apparatus of FIGS. 14 and 15, shown in the OPENED position;

FIG. 19 is an isometric view of another container apparatus, in accordance with another non-limiting embodiment of the disclosed concept;

FIGS. 20-22 are different views of a member for the container apparatus of FIG. 19;

FIGS. 23 and 24 are isometric and bottom views, respectively, of the container apparatus of FIG. 19, shown without the member;

FIGS. 25 and 26 show the container apparatus of FIG. 19 at different stages during assembly;

FIGS. 27-29 show the container apparatus with the member in different positions during opening of the container apparatus of FIG. 19;

FIG. 30 shows an isometric view of a container and a tool, shown with the container closed and before the tool has engaged the container;

FIG. 31 shows another isometric view of the container and tool of FIG. 30, with the tool partially inserted into the container;

FIG. 32 shows another isometric view of the container and tool of FIG. 30, with the tool fully inserted into the container;

FIG. 33 shows another isometric view of the container and tool of FIG. 30, with the tool opening the container;

FIG. 34 shows the container of FIG. 30 depicted in an opened position;

FIGS. 35-38 show different views of the tool of FIG. 30;

FIGS. 39 and 40 show different views of a lid for the container of FIG. 30;

FIG. 41 is an isometric view of another container apparatus, in accordance with another non-limiting embodiment of the disclosed concept;

FIGS. 42 and 43 are section views of the container apparatus of FIG. 41, taken along line B-B of FIG. 41;

FIG. 44 is an enlarged view of the section view of FIG. 43;

FIG. 45 shows a section view of a portion of the container apparatus of FIGS. 42 and 43, with a component of the lid engaging a member of the body;

FIG. 46 is another section view of a portion of the container apparatus of FIGS. 42 and 43, with a protrusion of the lid being disengaged with the body;

FIGS. 47-49 are different views of a portion of another container apparatus, shown with a zipper member in different positions, in accordance with another non-limiting embodiment of the disclosed concept; and

FIGS. 50-53 are different views of the zipper member of FIGS. 47-49.

### DETAILED DESCRIPTION OF THE PREFERRED EMBODIMENTS

As employed herein, the statement that two or more parts or components “engage” one another shall mean that the parts exert a force against one another either directly or through one or more intermediate parts or components. As employed herein, the term “number” shall mean one or an integer greater than one. As employed herein, the statement that two or more parts are “coupled” together shall mean that the parts are joined together either directly or joined through one or more intermediate parts.

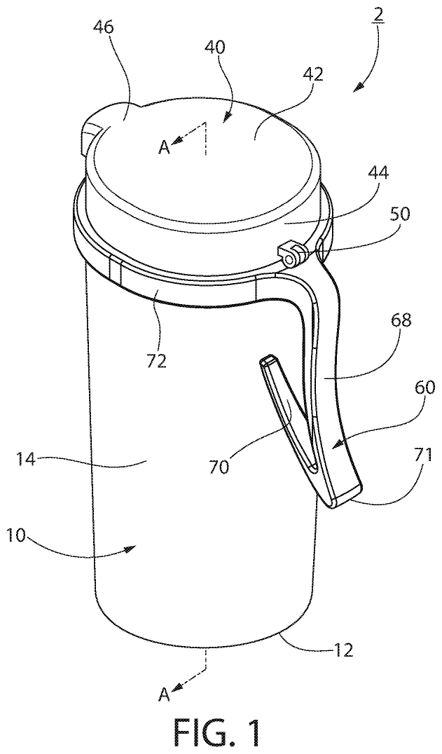

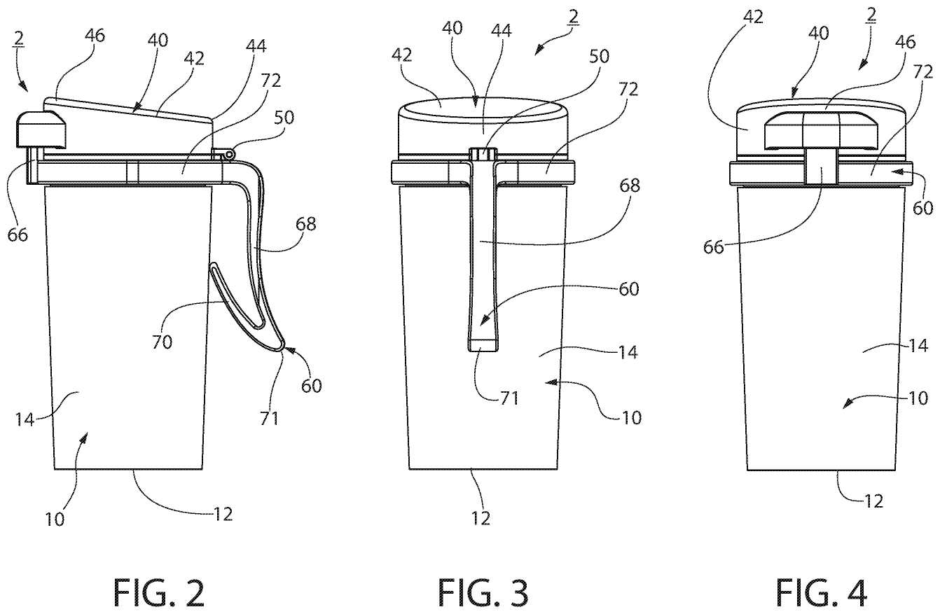

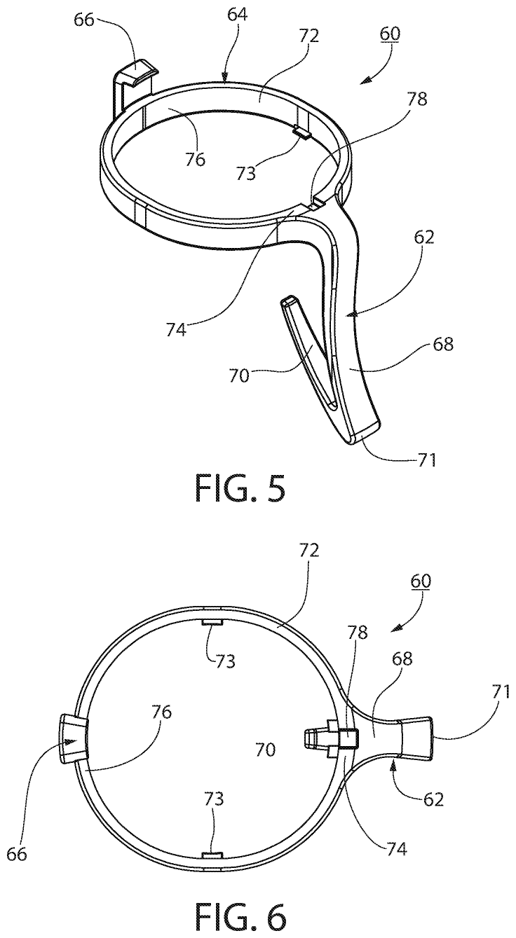

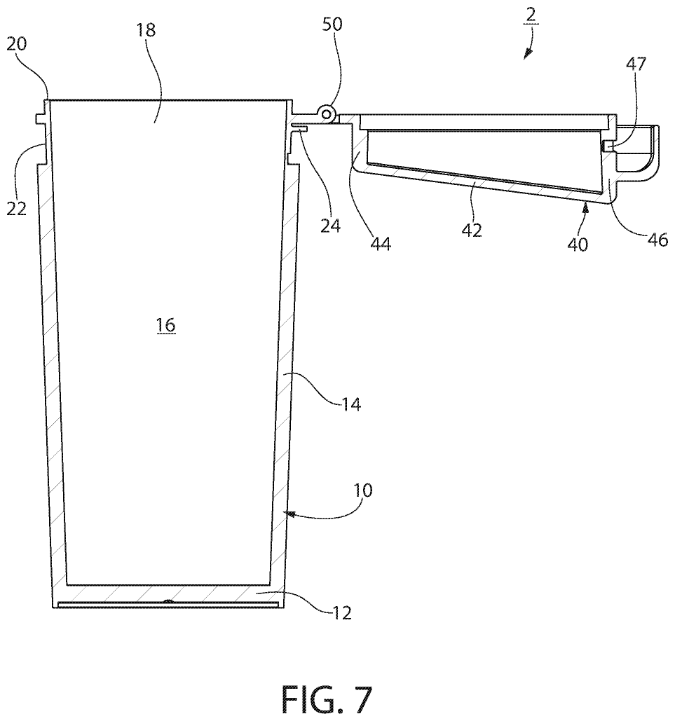

FIGS. 1-4 show different views of a novel container apparatus 2, in accordance with a non-limiting embodiment of the disclosed concept. Container apparatus 2 includes a body 10, a lid 40, and a trigger member 60 (see also, for example, FIGS. 5 and 6). As shown in FIG. 7, body 10 has a base 12 and a sidewall 14 extending from base 12. Lid 40 is configured to be attached to sidewall 14 via a hinge 50, and trigger member 60 is connected to hinge 50, as will be discussed below. Body 10 defines an interior 16, and has an opening 18 leading to interior 16. Interior 16 includes a product space configured for housing at least one product such as, for example, pills, tablets, gel-caps, capsules, or the like.

Continuing to refer to FIG. 7, sidewall 14 has a top portion 20 located opposite and distal from base 12, and an annular-shaped grooved region 22 located proximate top portion 20. Furthermore, body 10 has a protrusion 24 located proximate hinge 50 and extending outwardly from sidewall 14. Additionally, lid 40 has a body portion 42 having a first end 44 located at hinge 50, and a second end 46 located opposite and distal first end 44. As shown, second end 46 has a grooved region 47.

Referring to FIGS. 5 and 6, trigger member 60 has a gripping portion 62, a latching portion 64 extending from gripping portion 62, and a hook portion 66 extending outwardly from latching portion 64 and being located opposite gripping portion 62. Gripping portion 62 includes a first element 68 and optionally a second element 70 extending from first element 68. Latching portion 64 includes a ring-shaped portion 72 and a number of flexible protrusions 73 extending radially inwardly from ring-shaped portion 72. Ring-shaped portion 72 has a first end 74 and a second end 76 located opposite and distal first end 74. Hook portion 66 extends from second end 76. First end 74 has a grooved region 78. In one example embodiment, trigger member 60 is a unitary component made from a single piece of material (e.g., without limitation, an injection-molded piece).

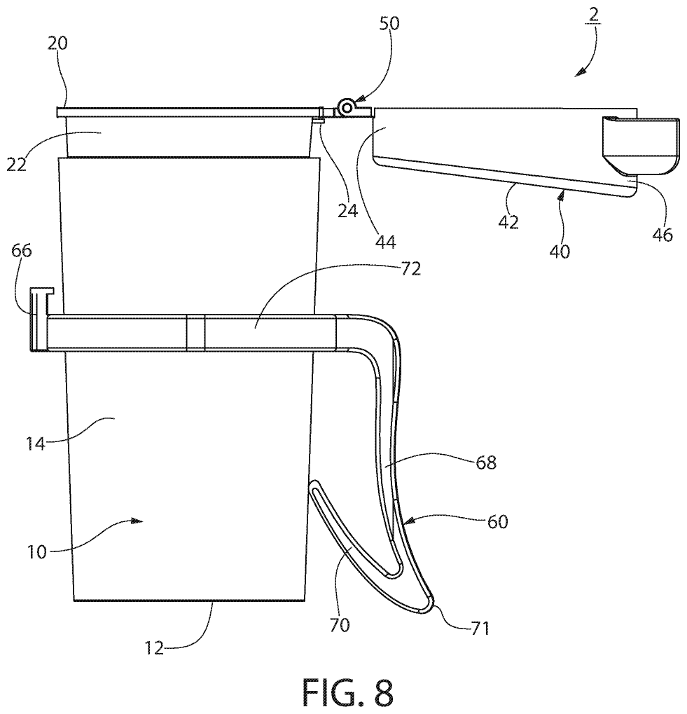

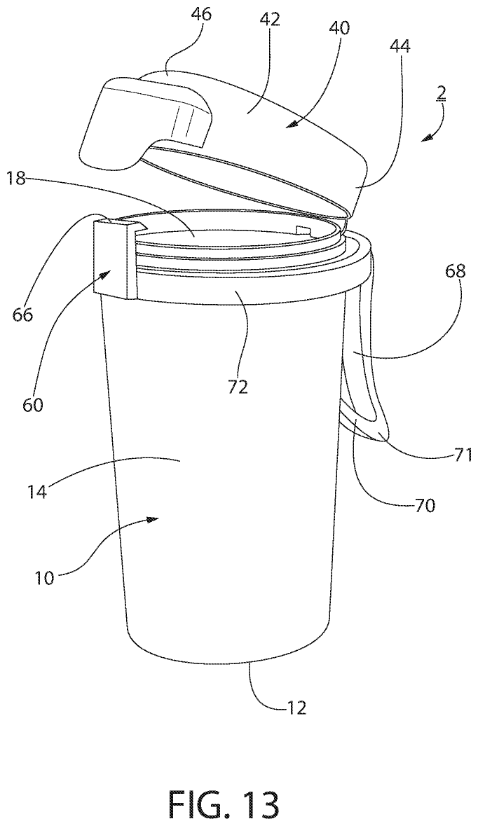

Referring to FIGS. 8-13, assembly and functionality of container apparatus 2 will now be described in detail. As shown in FIG. 8, sidewall 14 is located internal with respect to ring-shaped portion 72. It will thus be appreciated that in order to assemble container apparatus 2, sidewall 14 is first inserted into ring-shaped portion 72. Next, ring-shaped portion 72 is moved toward top portion 20 of sidewall 14 until protrusions 73 (FIGS. 5 and 6) reach and engage against grooved region 22. When ring-shaped portion 72 reaches grooved region 22, protrusions 73 optionally snap into engagement with grooved region 22. Accordingly, the engagement between protrusions 73 (FIGS. 5 and 6) and grooved region 22 advantageously prevents trigger member 60 from moving longitudinally with respect to body 10, and maintains trigger member 60 on body 10. In this manner, sidewall 14 is separately coupled to ring-shaped portion 72. When ring-shaped portion 72 is positioned in grooved region 22, trigger member 60 provides a child-resistant mechanism to maintain container apparatus 2 in a CLOSED position, and a senior-friendly mechanism by which container apparatus 2 can be moved to an OPENED position. Accordingly, container apparatus 2 is structured to move between a CLOSED position corresponding to lid 40 covering opening 18, and an OPENED position wherein lid 40 does not cover opening 18.

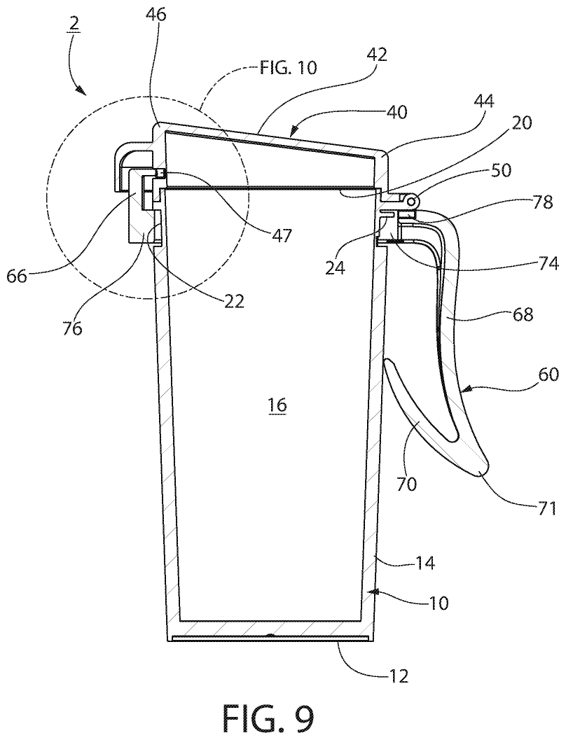

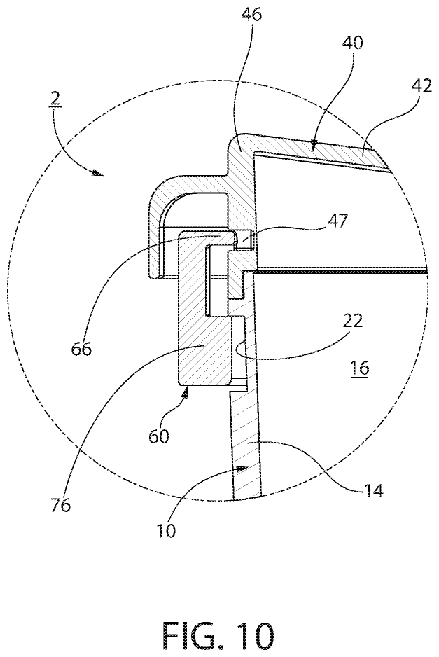

FIGS. 9 and 10 show section views of container apparatus 2 in the CLOSED position. As shown, when container apparatus 2 is in the CLOSED position, hook portion 66 of trigger member 60 extends into and engages grooved region 47 of lid 40 in order to maintain container apparatus 2 in the CLOSED position. In this manner, when container apparatus 2 is in the CLOSED position, hook portion 66 and grooved region 47 cooperatively keep lid 40 closed, and also prevent ring-shaped portion 72 from rotating with respect to body 10. As such, an attempt by a child to open lid 40 would likely result in hook portion 66 preventing lid 40 from opening via its engagement with grooved region 47. Additionally, first element 68 extends from first end 74 away from top portion 20 of sidewall 14, and second element 70 extends from first element 68 toward top portion 20 of sidewall 14. As shown, second element 70 engages sidewall 14. In this manner, first and second elements 68,70 bias second end 76 toward engagement with sidewall 14 (i.e., and thus bias hook portion 66 toward engagement with grooved region 47).

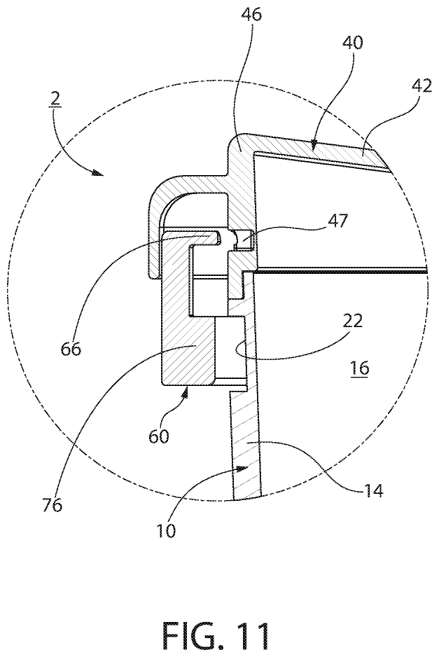

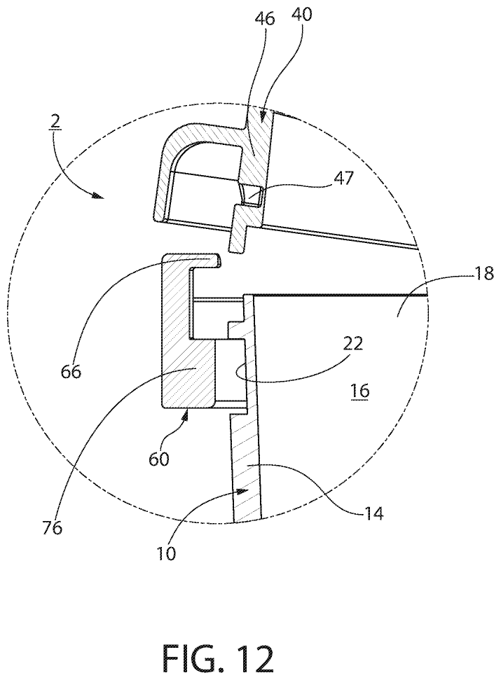

When container apparatus 2 moves from the CLOSED position toward the OPENED position, distal portion 71 of trigger member 60 moves toward interior 16. This may be, for example, responsive to a user squeezing trigger member 60. When this happens, hook portion 66 moves out of engagement with grooved region 47. See, for example, FIG. 11, in which trigger member 60 has been squeezed in order to move hook portion 66 out of engagement with grooved region 47. Accordingly, lid 40 is thus able to be moved to the OPENED position. See, for example, FIG. 12, in which after hook portion 66 has been disengaged from grooved region 47, lid 40 can readily be opened. It will be appreciated that when container apparatus 2 moves from the CLOSED position to the OPENED position, grooved region 78 (FIG. 9) moves toward body 10 until protrusion 24 extends into and engages grooved region 78. In this position, the engagement between protrusion 24 and grooved region 78 provides a mechanism to prevent rotational movement of ring-shaped portion 72 with respect to body 10.

Container apparatus 2 thus provides a novel mechanism to minimize the likelihood of inadvertent opening (e.g., by a child) of lid 40, but also provides a relatively simple mechanism by which an adult can open container apparatus 2. More specifically, opening lid 40 generally requires a two-part motion. First, a user must squeeze trigger member 60, thus removing hook portion 66 from grooved region 47. Second, the user must open lid 40.

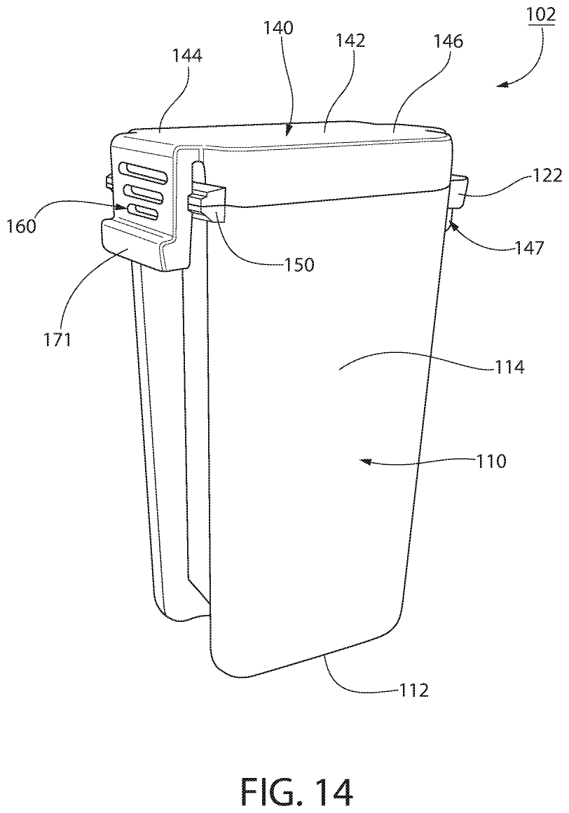

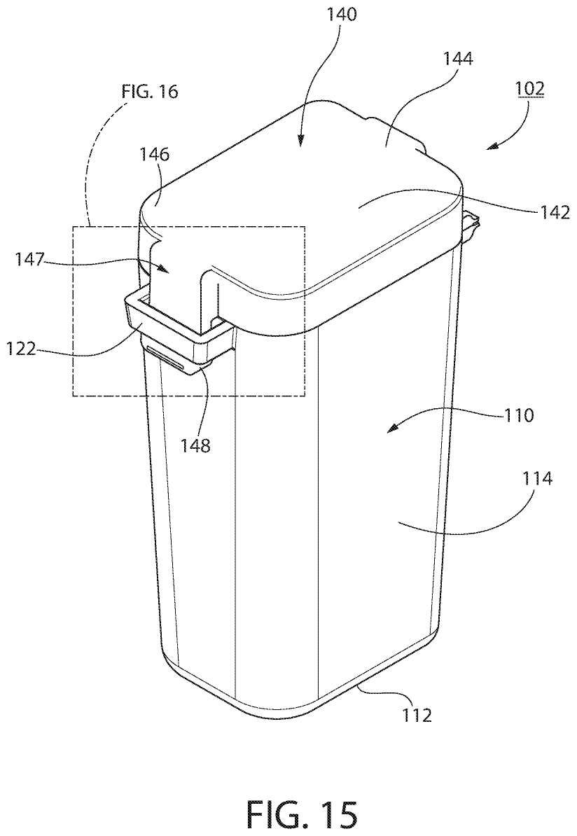

FIGS. 14-18 depict different views of another container apparatus 102, in accordance with another non-limiting embodiment of the disclosed concept. Container apparatus 102, like container apparatus 2, discussed above, provides a novel child-resistant senior-friendly opening mechanism. In one example embodiment, container apparatus 102 is a unitary component made of a single piece of material (e.g., without limitation, an injection-molded piece).

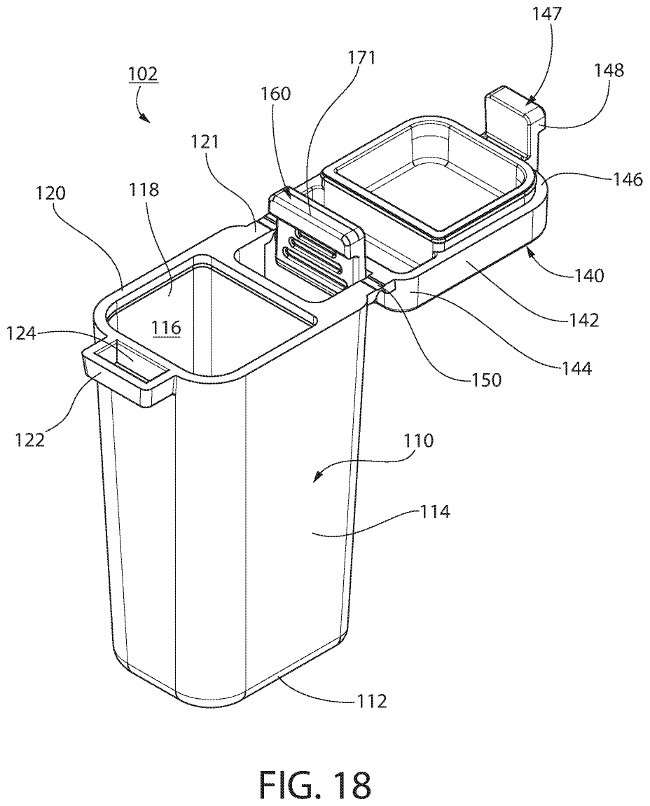

Container apparatus 102 includes a body 110, a lid 140, and a trigger member 160. Body 110 includes a base 112 and a sidewall 114 extending from base 112. As shown in FIG. 18, body 110 defines an interior 116 including a product space configured for housing at least one product (e.g., without limitation, pills, tablets, gel-caps, capsules, or the like), and has an opening 118 leading to interior 116. Lid 140 is attached to sidewall 114 by a hinge 150, and in one example embodiment, trigger member 160 is integral with hinge 150. Trigger member 160 has a distal portion 171 located opposite hinge 150 and external with respect to interior 116 (FIG. 18). Lid 140 has a body portion 142 having a first end 144 and a second end 146 located opposite and distal first end 144, and an elongated member 147 extending outwardly from second end 146. Elongated member 147 includes a latch 148 located opposite and distal second end 146. First end 144 is located at hinge 150. As will be discussed below, elongated member 147 is structured to cooperate with trigger member 160 as container apparatus 2 moves from a CLOSED position, shown in FIGS. 14-16, to an OPENED position, shown in FIG. 18.

Accordingly, container apparatus 2 is structured to move between a CLOSED position (FIGS. 14-16) corresponding to lid 140 covering opening 118, and an OPENED position (FIG. 18) wherein lid 140 does not cover opening 118. In order to move between positions, and also provide a novel child-resistant senior-friendly opening mechanism, body further has a guard or protrusion 122 extending outwardly from a first top portion 120 of sidewall 114, a protrusion that is structured to cooperate with elongated member 147 of lid 140. As shown most clearly in FIG. 18, protrusion 122 has an aperture 124. Furthermore, protrusion 122 is located opposite and distal hinge 150. More specifically, sidewall 114 has a second top portion 121 opposite and distal first top portion 120, and second top portion 121 is located at hinge 150.

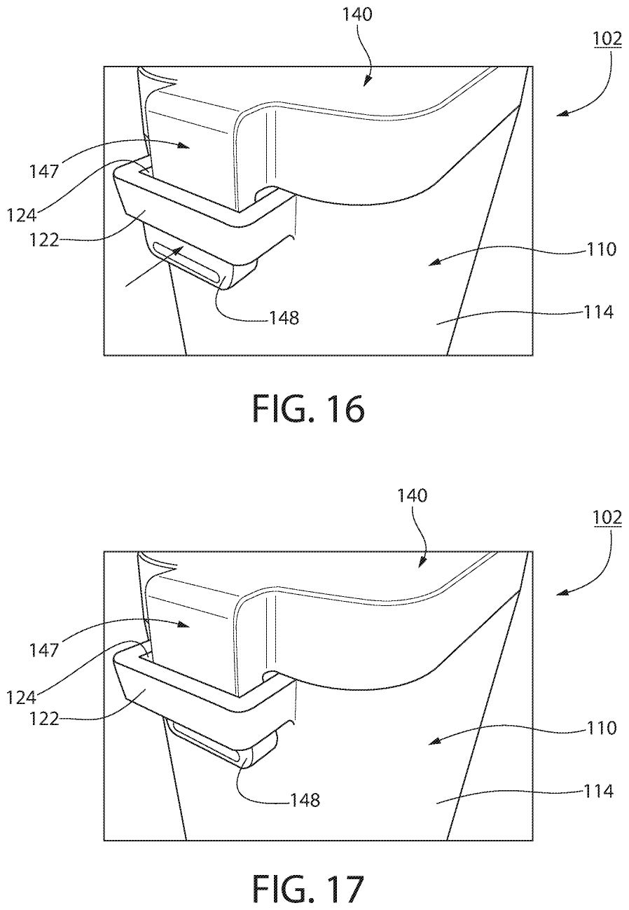

Moving container apparatus 102 from the CLOSED position toward the OPENED position requires two steps, which together substantially minimize the likelihood that lid 140 will be inadvertently opened, such as, by a child. When container apparatus 2 is in the CLOSED position, elongated member 147 extends into aperture 124 of protrusion 122, and latch 148 interlocks with protrusion 122 in order to maintain container apparatus 102 in the CLOSED position. The first step in opening container apparatus 102 involves deflecting latch 148. Compare, for example, FIGS. 16 and 17, which show latch 148 interlocked with and freed from protrusion 122, respectively. This change of positions may be done by a user pressing latch 148 toward sidewall 114. Accordingly, when latch 148 has been pressed toward sidewall 114 and is in the position depicted in FIG. 17, lid 140 may be opened. This may be accomplished by the second opening step, which involves squeezing trigger member 160. Accordingly, when container apparatus 102 moves from the CLOSED position toward the OPENED position, distal portion 171 initially moves toward interior 116 (i.e., as trigger member 160 is squeezed). In other words, when container apparatus 102 moves from the CLOSED position to the OPENED position, elongated member 147 initially moves toward interior 116, thereby allowing trigger member 160 to open lid 140. While these two opening steps may be rather difficult for a child to contemplate, an adult can readily be able to open container apparatus 102 without much difficulty. As a result, container apparatus 102, like container apparatus 2, provides advantages in terms of protecting children from potentially accessing contents in container apparatus 102, and also providing a relatively simple mechanism for an adult to open.

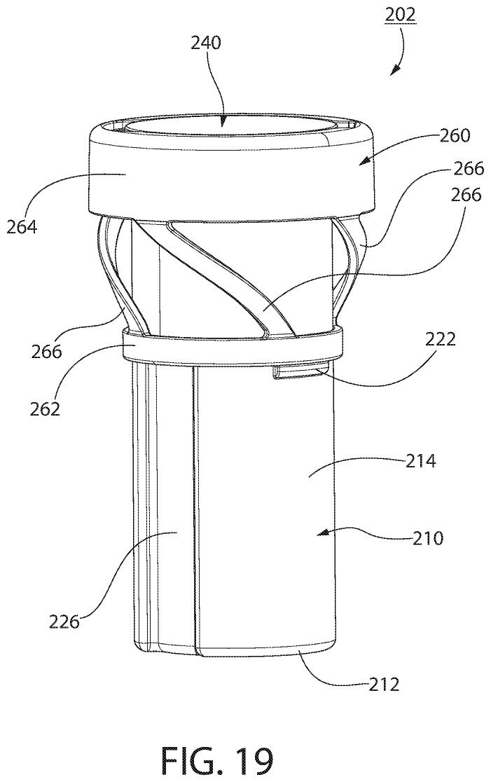

FIG. 19 shows an isometric view of another container apparatus 202, in accordance with another non-limiting embodiment of the disclosed concept. Container apparatus 202 includes a body 210, a lid 240, and a member 260. As will be discussed below, the interaction between body 210, lid 240, and member 260 minimizes the likelihood that container apparatus 202 will be easily opened (i.e., by a child), but still provides an opening mechanism that an adult can readily understand.

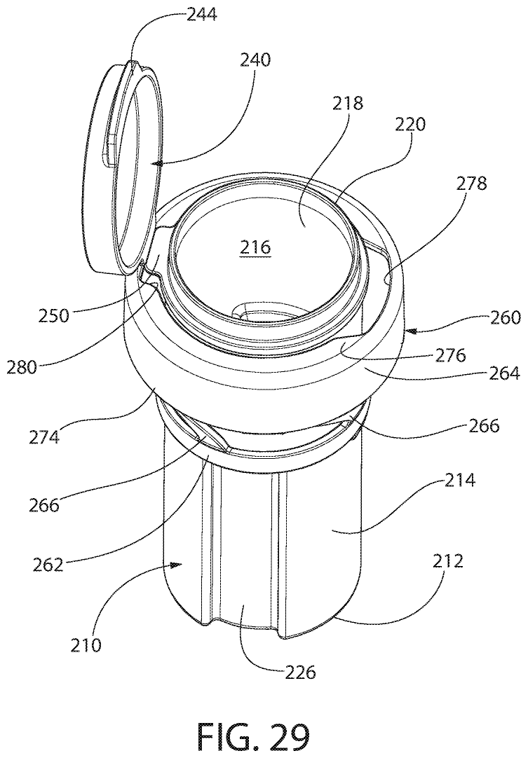

Body 210 includes a base 212 and a sidewall 214 extending from base 212. Body 210 also defines an interior 216 (FIG. 29) and has an opening 218 (FIG. 29) leading to interior 216. Interior 216 includes a product space configured for housing at least one product (e.g., without limitation, pills, tablets, gel-caps, capsules). Lid 240 is configured to be attached to sidewall 214 by a hinge 250, and is structured to move between a CLOSED position (FIGS. 19, 23-28) corresponding to lid 240 covering opening 218, and an OPENED position (FIG. 29) wherein lid 240 does not cover opening 218.

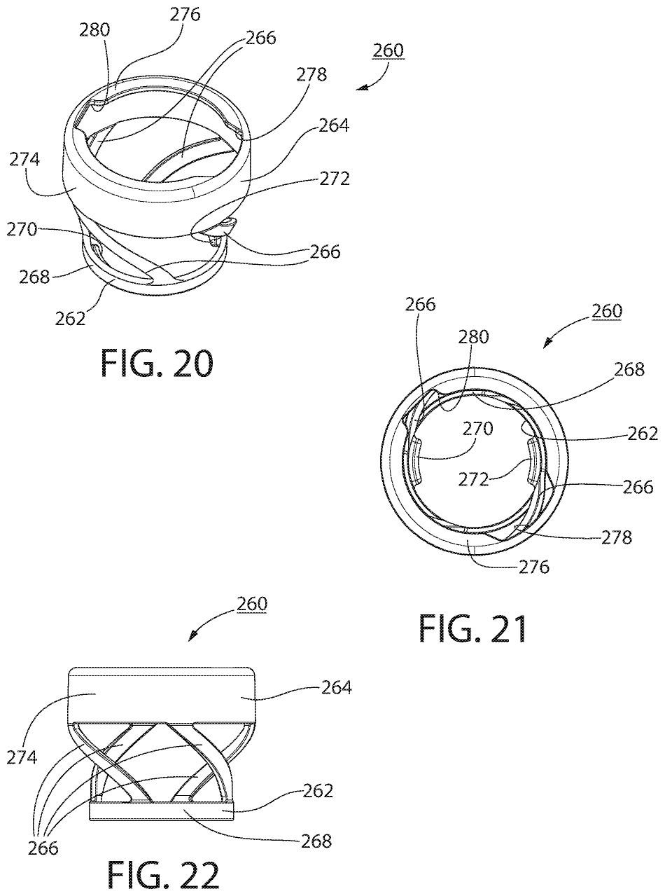

FIGS. 20-22 depict different views of member 260. Member 260 includes an annular-shaped coupling portion 262, a securing portion 264, and a number of connecting elements 266 connecting coupling portion 262 to securing portion 264. Coupling portion 262 includes a ring-shaped portion 268 and a number of protrusions 270,272 extending radially inwardly from ring-shaped portion 268. Securing portion 264 includes a cylindrical-shaped portion 274 and a lip 276 extending from and being located generally perpendicular to cylindrical-shaped portion 274. As shown most clearly in FIG. 20, lip 276 has a first grooved region 278 and a second grooved region 280 located opposite and distal first grooved region 278. The construction of member 260 advantageously allows it to minimize the likelihood that lid 240 will be opened by a child.

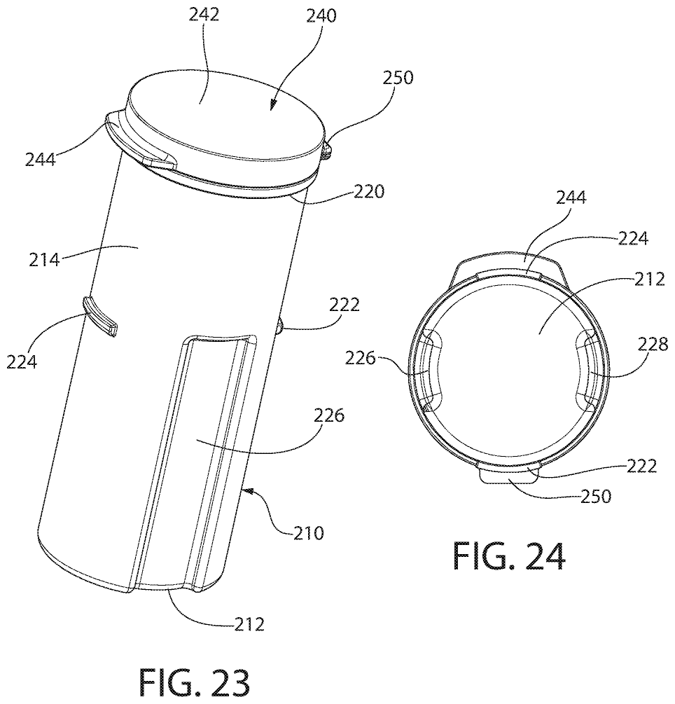

Referring to FIGS. 23 and 24, the geometry of body 210 and lid 240 will now be discussed in detail. As shown, body 210 further has a number of protrusions 222,224 extending outwardly from sidewall 214 away from interior 216 (FIG. 29). Furthermore, sidewall 214 has a number of elongated grooved regions 226,228 extending from base 212 toward lid 240. Lid 240 includes a cover portion 242 and a gripping portion 244 extending outwardly from cover portion 242 and being located opposite and distal hinge 250.

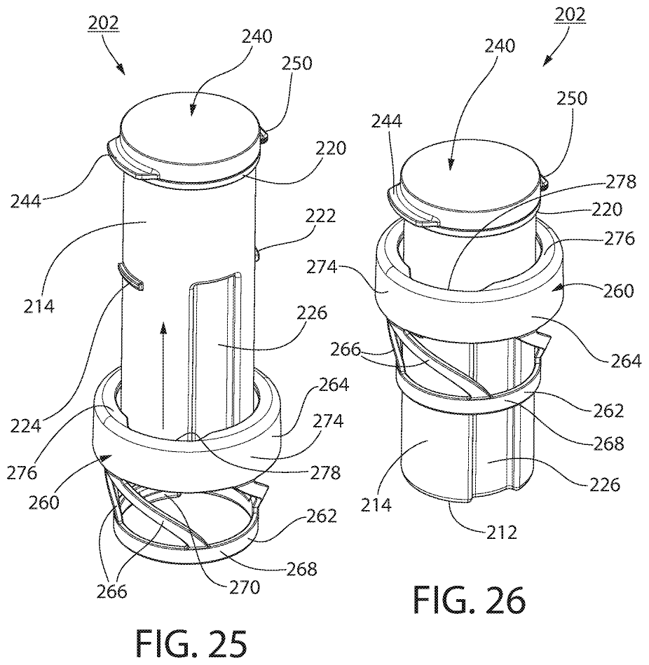

In order to assemble container apparatus 202, protrusions 270,272 of member 260 are aligned with grooved regions 226,228 of body 210, as shown in FIGS. 25 and 26. Accordingly, body 210 is inserted into member 260, with sidewall 214 being located internal with respect to coupling portion 262, and with protrusions 270,272 of member 260 being located in and engaging corresponding grooved regions 226,228 in order to prevent rotational movement of coupling portion 262 with respect to sidewall 214. Additionally, the interaction between ring-shaped portion 268 of member 260 and protrusions 222,224 of body 210 advantageously prevents longitudinal movement of coupling portion 262 with respect to sidewall 214. As member 260 is installed on body 210, securing portion 264 is moved from proximate base 212 toward lid 240. Compare, for example, the position of member 260 in FIGS. 25 and 26. In one example embodiment of the disclosed concept, member 260 is made of a flexible material (e.g., without limitation, a thermoplastic material).

Continued movement of securing portion 264 toward lid 240 results in ring-shaped portion 268 engaging protrusions 222,224. Because member 260 is relatively flexible, an assembler of container apparatus 202 can readily stretch ring-shaped portion 268 over protrusions 222,224 of body 210 so that protrusions 222,224 are located between ring-shaped portion 268 and base 212. In this manner, coupling portion 262 engages each of protrusions 222,224 in order to prevent longitudinal movement of coupling portion 262 with respect to sidewall 214. As such, coupling portion 262 is coupled to sidewall 214.

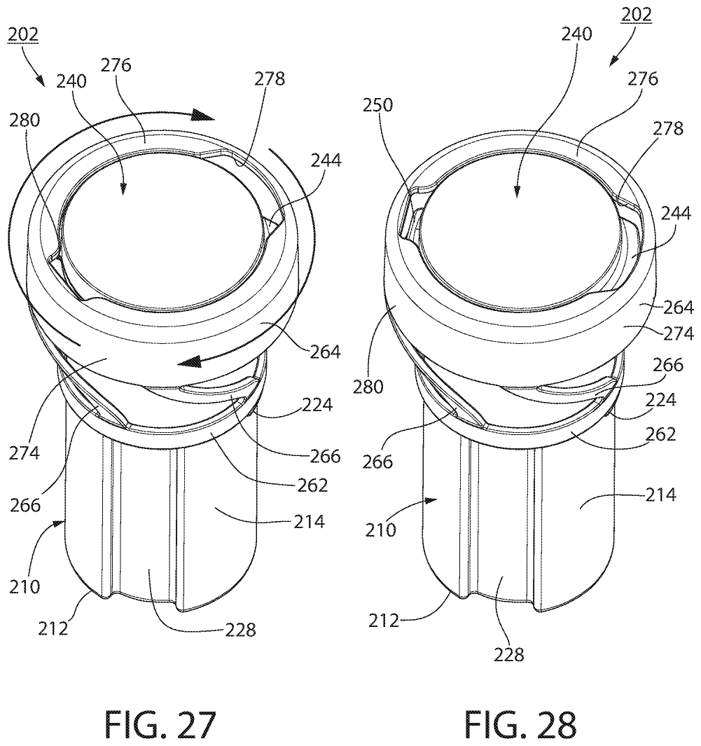

Referring to FIGS. 27-29, movement of lid 240 from the CLOSED position (FIG. 27) to the OPENED position (FIG. 29) will now be discussed in detail. In order to allow lid 240 to move between positions, and also minimize the likelihood that container apparatus 202 may be accessed by a child, member 260 is structured to move between a FIRST position (FIG. 27) corresponding to securing portion 264 engaging lid 240 in order to maintain lid 240 in the CLOSED position, and a SECOND position (FIG. 29) wherein securing portion 264 does not engage lid 240. Specifically, as shown in FIG. 27, when member 260 is in the FIRST position, lip 276 engages gripping portion 244 in order to maintain lid 240 in the CLOSED position. Although not shown, it will be appreciated that hinge 250 is also engaging lip 276 when member 260 is in this FIRST position. As a result, lip 276 prevents lid from being opened. However, when member 260 moves from the FIRST position toward the SECOND position, securing portion 264 revolves around a top portion 220 (FIG. 29) of sidewall 214 in order to allow lid 240 to move from the CLOSED position to the OPENED position. Furthermore, because of the engagement between protrusions 270,272 of member 260 and corresponding grooved regions 226,228 of body 210, when member 260 moves from the FIRST position toward the SECOND position, coupling portion 262 remains fixed with respect to sidewall 214.

When member 260 moves from the FIRST position to the SECOND position, first grooved region 278 and second grooved region 280 rotate until gripping portion 244 and hinge 250 fit within first and second grooved regions 278,280, respectively, in order to allow lid 240 to move from the CLOSED position toward the OPENED position. Because coupling portion 262 remains fixed with respect to sidewall 214 during movement of member 260, it will be appreciated that when member 260 moves from the FIRST position toward the SECOND position, securing portion 264 moves toward coupling portion 262. For example and without limitation, after a user has rotated securing portion 264 such that hinge 250 and gripping portion 244 are aligned with grooved regions 278,280, securing portion 264 is thus unobstructed, and can be moved down toward coupling portion (i. e., by virtue of the relatively flexible connecting elements 266) to allow lid 240 to be opened. This opening mechanism is advantageously relatively simple for an adult to understand and manipulate, but configured to be too complex for a young child, thus affording its users benefits in terms of protection to children who may attempt to access the contents of container apparatus 202.

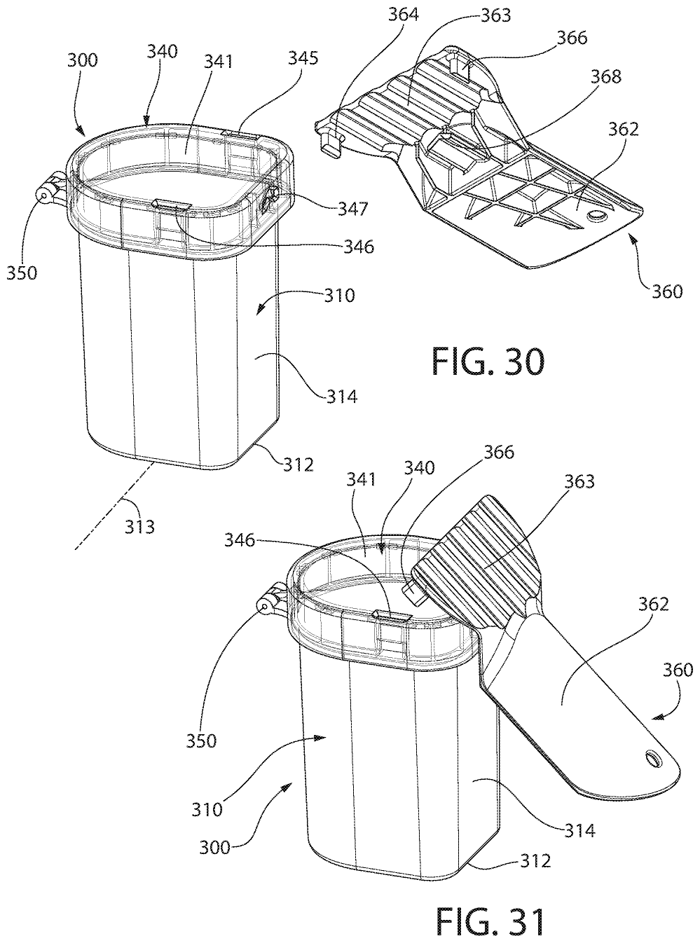

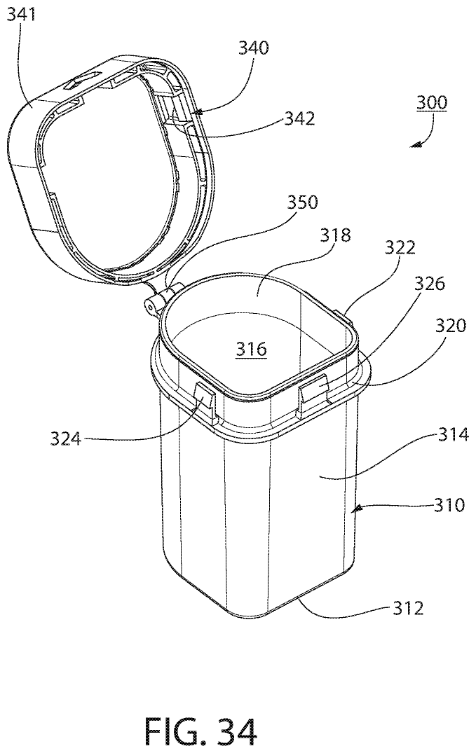

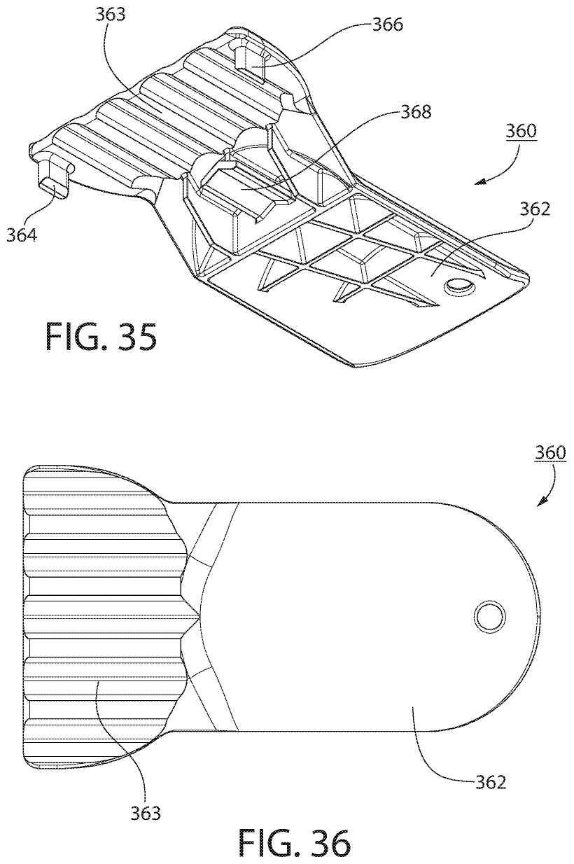

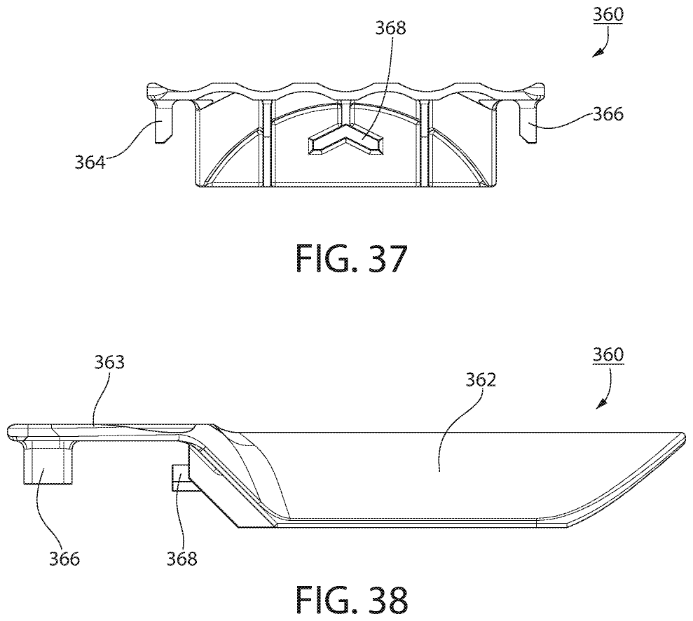

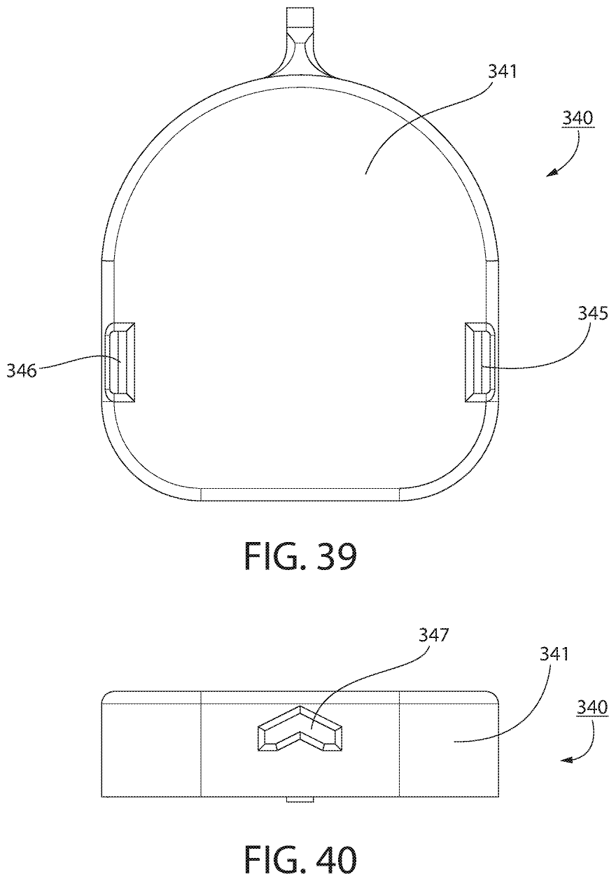

FIGS. 30-33 show different views of a container 300 and a tool 360 used to open container 300, in accordance with another non-limiting embodiment of the disclosed concept. FIG. 34 shows container 300 in an opened position, FIGS. 35-38 show different views of tool 360, and FIGS. 39 and 40 show different views of a lid 340 for container 300. Container 300 and tool 360 provide a unique child-resistant senior-friendly opening mechanism to protect children without significantly burdening adults who wish to access contents of the container 300.

Referring to FIG. 34, container 300 further includes a body 310 having a base 312 and a sidewall 314 extending from base 312. Body 310 defines an interior 316 and has an opening 318 leading to interior 316. Interior 316 includes a product space configured for housing at least one product (e.g., without limitation, pills, tablets, gel-caps, capsules). Lid 340 is configured to be attached to sidewall 314 via a hinge 350.

Continuing to refer to FIG. 34, sidewall 314 includes a top portion 320 and a number of latching members 322,324,326 extending from top portion 320. Lid 310 includes a body portion 341 and a number of latching members provided thereon. One such latching member 342 is illustrated by the view shown in FIG. 34. However, it should be appreciated that lid may further include two other latching members in this embodiment, each positioned and aligned to interlock with a corresponding one of latching members 324,326 of body 310. Furthermore, as shown in FIGS. 39 and 40, body portion 341 has a number of thru holes 345,346,347. When container 300 is in a closed position (FIG. 30), latching members 342 of lid interlock with latching members 322,324,326 of body, retaining the lid 310 in a CLOSED position. Referring to FIGS. 35-38, tool 360 includes a gripping portion 362 and a number of protrusions 364,366,368 extending outwardly from gripping portion 362. Tool 360 also includes a ribbed portion 363 for increasing the ability of tool 360 to withstand loads (i.e., during opening of container 300).

Referring to FIGS. 30-33, a method of opening container 300 will now be described in detail. The method includes the steps of providing container 300 with body 310 and lid 340, providing sidewall 314 with top portion 320 and latching members 322,324,326 extending therefrom, providing lid 340 with body portion 341 and latching members 342 extending therefrom, each of latching members 342 of lid 340 being interlocked with a corresponding one of latching members 322,324,326 of sidewall 314, providing tool 360, inserting each of protrusions 364,366,368 of tool 360 through a corresponding one of thru holes 345,346,347 in order to release latching members 342 of lid 340 from latching members 322,324,326 of sidewall 314, and pivoting tool 360 about hinge 350 in order to open container 300.

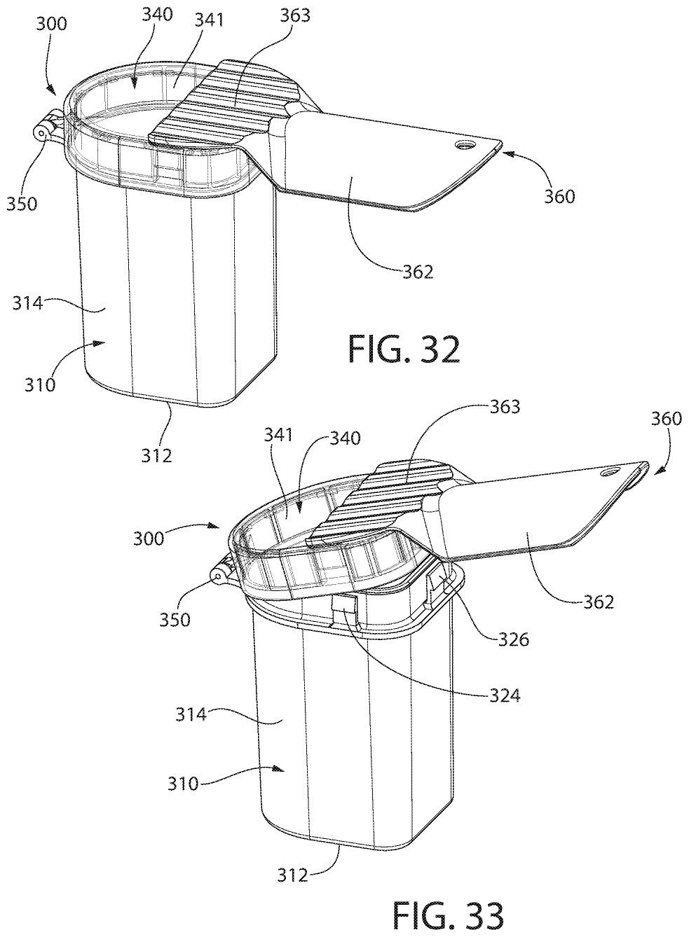

As shown in FIGS. 30 and 31, during opening, protrusion 368 is first inserted into thru hole 347 in order to release latching member 326 of body 310 from the corresponding latching member of lid 340. Next, protrusions 364,366 are inserted through thru holes 345,346 in order to release latching members 322,324 from latching members 342 (i.e., and the other corresponding opposing latching member of lid 340). This is depicted in FIGS. 32 and 33. Accordingly, once protrusions 364,366,368 are fully inserted through thru holes 345,346,347, as shown in FIG. 32, lid 340 can readily be opened by pivoting tool 360 about hinge 350. Compare, for example, the position of tool 360 in FIG. 32, before lid 340 has been opened, to the position of tool 360 in FIG. 33, after lid 340 has begun to open. The inserting step of the method may further include deflecting each of latching members 322,324,326 of sidewall 314 inwardly toward interior 316. The inserting step may also further include inserting protrusions 364,366 in a direction toward base 312 while protrusion 368 is inserted in a direction parallel to a plane 313 (FIG. 30) of base 312.

Accordingly, it will be appreciated that container 300 and tool 360 provide a unique child-resistant mechanism to minimize the likelihood that container 300 will be opened by a young child, but provide a relatively simple mechanism by which an adult can open container 300. Specifically, without tool 360, container 300 is relatively difficult to open. This provides a first layer of protection against access to the contents of container 300 by a child in that the adult can simply hide tool 360 from the child. Moreover, even if a child were to have access to both tool 360 and container 300, a second layer of protection is provided in that the child would have to be able to properly align protrusions 364,366,368 with thru holes 345,346,347, and then pivot tool 360 about hinge 350. However, while difficult for a child, accessing the contents of container 300 by an adult is relatively simple, and may be accomplished as described herein.

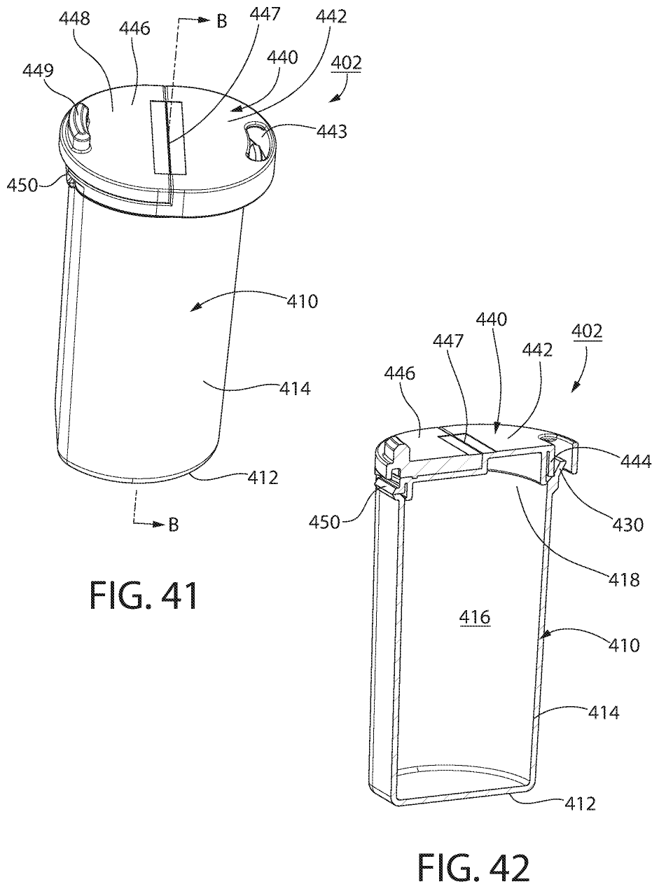

FIGS. 41-46 depict different views of another container apparatus 402, in accordance with another non-limiting embodiment of the disclosed concept. Container apparatus 402 has a unique child-resistant senior-friendly mechanism to be opened, as will be discussed below.

Container apparatus 402 includes a body 410 and a lid 440, and in one example embodiment is a unitary element made from a single piece of material. Body 410 has a base 412, a sidewall 414 extending from base 412, and a member 430 extending outwardly from sidewall 414. As shown in FIG. 42, body 410 defines an interior 416 and has an opening 418 leading to interior 416. Interior 416 includes a product space configured for housing at least one product (e.g., without limitation, pills, tablets, gel-caps, capsules). Member 430 is located opposite base 412 and extends from sidewall 414 away from interior 416. Lid 440 is configured to be attached to sidewall 414 via a hinge 450. Lid 440 includes a cover portion 442 structured to cover opening 418, a protrusion 444 extending outwardly from and being located generally perpendicular to cover portion 442, and a component 446 connected to cover portion 442. Cover portion 442 has a thru hole 443. Component 446 includes a first portion 448 and a second portion 449 extending outwardly from and being located generally perpendicular with respect to first portion 448. First portion 448 is pivotably connected to cover portion 442 by a hinge, e.g., living hinge 447. Lid 440 is structured to move between a FIRST position (FIGS. 41-44) corresponding to cover portion 442 covering opening 418, and a SECOND position (FIG. 46) wherein cover portion 442 does not cover opening 418. When lid 440 is in the FIRST position, second portion 449 is located proximate hinge 450 and extends from first portion 448 away from base 412.

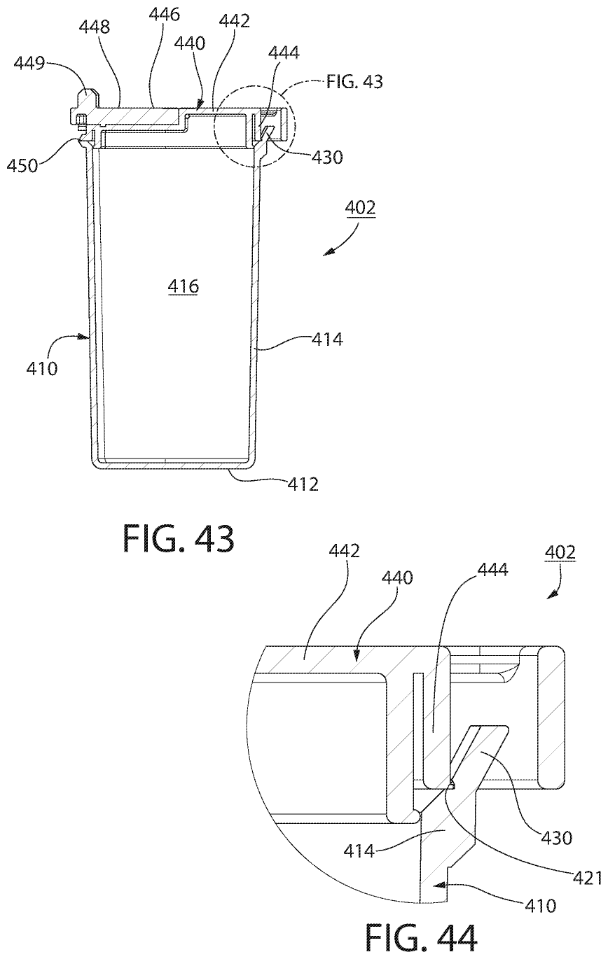

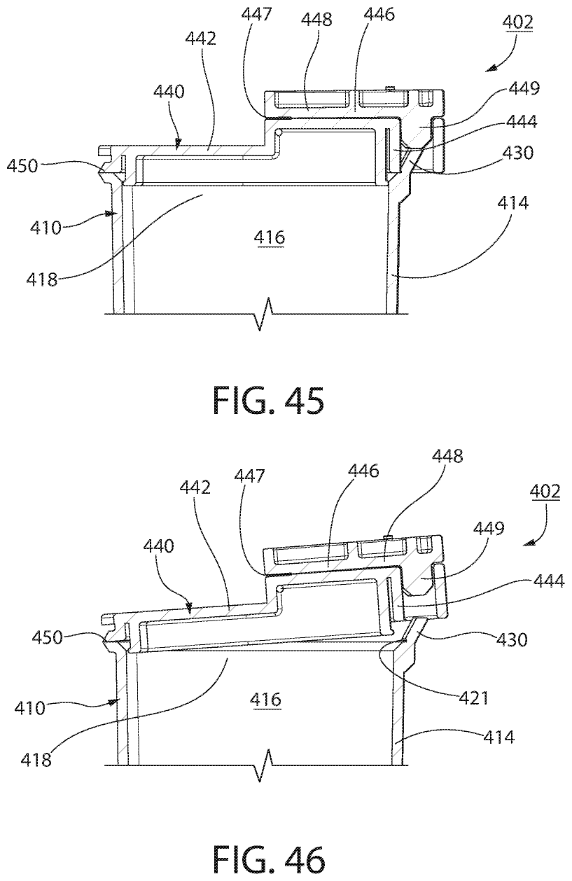

Referring to FIGS. 43 and 44, when lid 440 is in the FIRST position, protrusion 444 of lid 440 engages member 430 of body 410 in order to maintain lid 440 in the FIRST position. More specifically, as shown in FIG. 44, body 410 has a grooved region 421 between sidewall 414 and member 430. When lid 440 is in the FIRST position, protrusion 444 extends into grooved region 421 and latches onto member 430 in order to maintain lid 440 in the FIRST position. Comparing, for example, FIGS. 44 and 45, when lid 440 moves from the FIRST position (FIG. 44) toward the SECOND position, second portion 449 of component 446 moves into engagement with member 430 in order to disengage protrusion 444 from member 430. Stated differently, when lid 440 moves from the FIRST position toward the SECOND position, second portion 449 of component 446 extends through thru hole 443 in order to move into engagement with member 430. This causes member 430 to pivot about grooved region 421, thereby allowing protrusion 444 to move out of grooved region 421. As such, once protrusion 444 has been moved out of grooved region 421 by second portion 449, lid 440 can readily be opened. Compare, for example, the position of lid 440 in FIGS. 45 and 46.

It will thus be appreciated that container apparatus 402 provides another novel mechanism to protect children from accessing the contents of container apparatus 402, while being relatively simple for an adult to open. Specifically, unless a user pivots component 446 about hinge, e.g., living hinge 447 and pushes second portion 449 into member 430, lid 440 will generally not be able to be opened, as the engagement between grooved region 421 and member 430 with protrusion 444 maintains lid 440 in the CLOSED position. However, an adult will relatively easily be able to figure out how to open lid 440 via the above described process. Accordingly, advantages in terms of protecting children from accessing the potentially harmful contents within container apparatus 402 are thus realized.

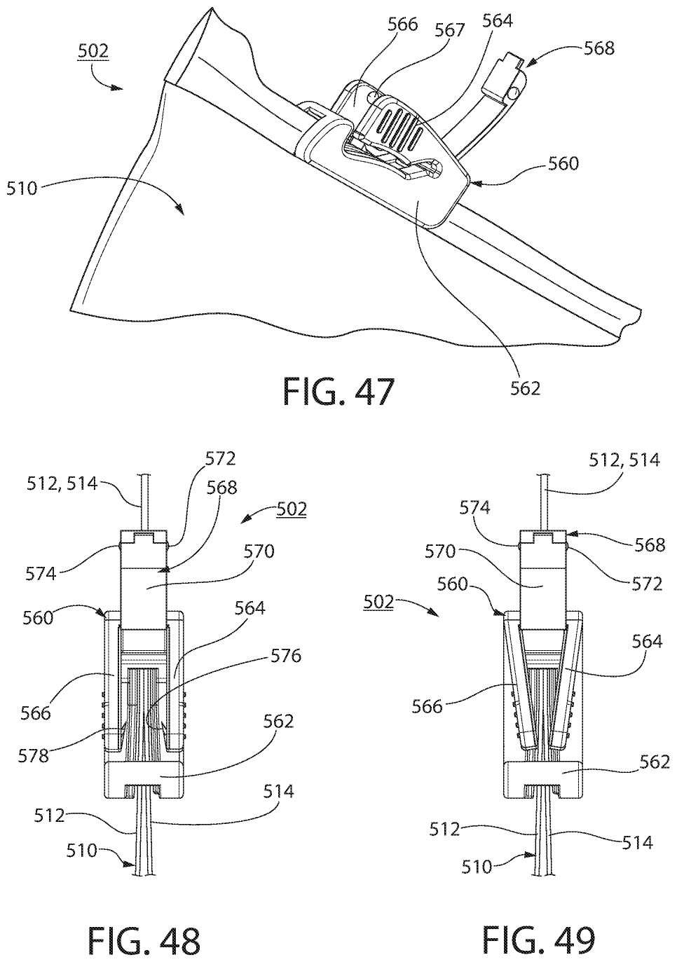

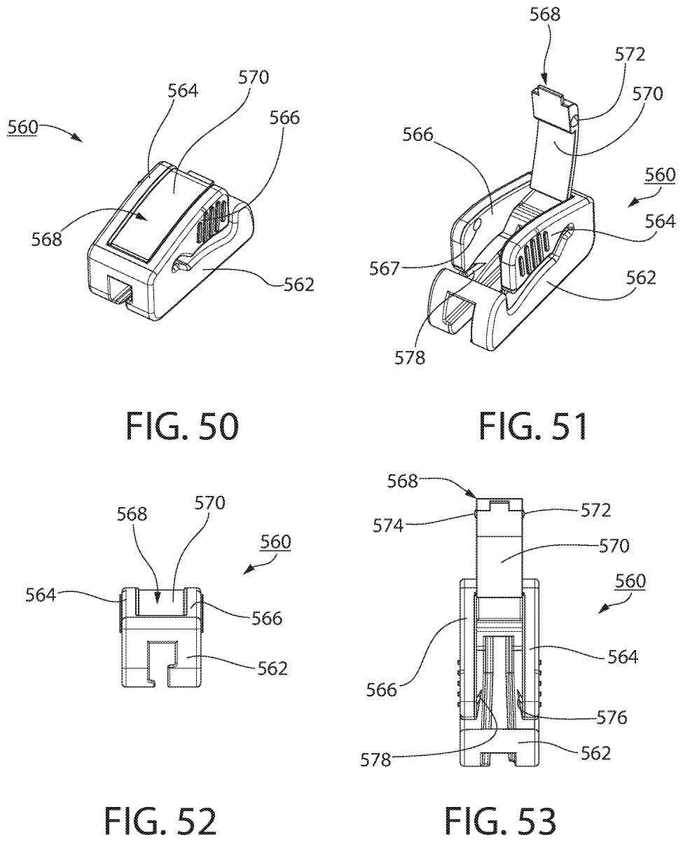

FIGS. 47-49 show different views of another container apparatus 502, in accordance with another non-limiting embodiment of the disclosed concept. Container apparatus 502 includes a bag 510 and a zipper member 560 (also shown in FIGS. 50-53). Bag 510 has a first end portion 512 and a second end portion 514 that are joined, e.g., at seams (although a bag without seams is also within the scope of the disclosed concept). Between the first end portion 512 and second end portion 514 is an opening leading to interior of bag 510. Bag 510 is structured to move between a FIRST position corresponding to first end portion 512 being interlocked with second end portion 514 to close the opening, and a SECOND position corresponding to first end portion 512 being spaced from second end portion 514, exposing the opening. See, for example, FIGS. 48 and 49, in which at the top of the FIGS. end portions 512,514 are depicted as a single component to represent that end portions 512,514 are interlocked with each other, and at the bottom of the FIGS. end portions 512,514 are spaced from each other. When bag 510 is in the FIRST position, end portions 512,514 are locked together to resist opening, e.g., by a child. Also in FIRST position, the bag optionally provides a generally moisture tight seal. In order to move bag 510 between the FIRST position (top of FIGS. 48 and 49) and the SECOND position (bottom of FIGS. 48 and 49), zipper member 560 is employed.

Zipper member 560 has a body 562, a pair of flexible opposing arms 564,566 extending from body 562, and a hood 568 extending from body 562. Body 562 is coupled to end portions 512,514 of bag 510. Referring to FIGS. 48 and 49, arms 564,566 are structured to move between a THIRD position (FIG. 48) corresponding to disengagement with end portions 512,514, and a FOURTH position (FIG. 49) corresponding to engagement end portions 512,514. It will be appreciated that arms 564,566 are biased toward the THIRD position, and generally move to the FOURTH position responsive to an external force such as, for example, being squeezed together by a user.

Referring to FIGS. 50-53, hood 568 is structured to move between a FIFTH position (FIGS. 51 and 53) corresponding to disengagement with arms 564,566, and a SIXTH position (FIGS. 50 and 52) corresponding to engagement with arms 564,566. When hood 568 is in the SIXTH position (FIGS. 50 and 52), hood 568 extends between arms 564,566 in order to maintain arms 564,566 in the THIRD position. In this manner, zipper member 560 is advantageously able to provide a novel child-resistant senior-friendly mechanism to open bag 510 and protect children from potentially harmful contents within bag 510 when the bag 510 is in the FIRST position.

More specifically, each of arms 564,566 has a corresponding grooved region (only one grooved region 567 is depicted in FIG. 51, although it will be appreciated that arm 564 also has a grooved region opposing grooved region 567). Hood 568 includes an elongated member 570 and a pair of opposing protrusions 572,574 each extending outwardly from elongated member 570. Furthermore, as shown most clearly in FIG. 53, each of arms 564,566 has a corresponding inwardly protruding plow member 576,578.

When hood 568 is in the SIXTH position (FIGS. 50 and 52), each of protrusions 572,574 is located in a corresponding one of grooved regions 567 (i.e., and the other opposing grooved region of arm 564, not shown). In this position, hood 568 is structured to prevent arms 564,566 from moving between positions because arms 564,566 cannot be squeezed together. When hood 568 is in the FIFTH position, arms 564,566, and more particularly plow members 576,578, are advantageously able to cause bag 510 to move between the FIRST position and the SECOND position. As such, when arms 564,566 move from the THIRD position to the FOURTH position, arms 564,566, responsive to being squeezed by a user, move toward each other such that plow members 576,578 move into engagement with end portions 512,514 of bag 510. When plow members 576,578 are engaged with end portions 512,514, plow members 576,578 can open and close bag 510. That is, if hood 568 is in the FIFTH position, and a user squeezes arms 564,566 toward each other, the user can open and close bag 510 by sliding zipper member 560 side to side along end portions 512,514.

The engagement between protrusions 572,574 and grooved regions 567 cannot readily be overcome absent an upward lifting motion of elongated member 570 to dislodge protrusions 572,574 from grooved regions 567. It will be appreciated that this motion is not readily apparent to a child, and thus results in hood 568 being maintained in the SIXTH position. As a result, children are protected from accessing the contents of bag 510. However, an adult can relatively easily contemplate opening hood 568 and squeezing arms 564,566. Accordingly, zipper member 560 provides a novel mechanism to protect children and allow adults easy access to the contents of bag 510.

The present disclosed concept has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosed concept that others can, by applying knowledge within the skill of the art, readily modify and/or adapt for various applications such specific embodiments, without undue experimentation, without departing from the general concept of the present disclosed concept. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present disclosed concept should not be limited by any of the above-described exemplary embodiments, but should be defined only in accordance with the following claims and their equivalents.

### Recitation of Exemplary Embodiments

The following exemplary embodiments further describe optional aspects of the invention and are part of this Specification. These exemplary embodiments are set forth in a format substantially akin to claims (each with a numerical designation followed by a letter designation), although they are not technically claims of the present application. The following exemplary embodiments refer to each other in dependent relationships as “embodiments” instead of “claims.”

1A. A container apparatus comprising:
a body having a base and a sidewall extending therefrom, the body defining an interior comprising a product space configured for housing at least one product, the body further having an opening leading to the interior;
a lid configured to be attached to the sidewall via a hinge; and
a trigger member connected to or integral with the hinge, the trigger member having a distal portion disposed opposite the hinge and external with respect to the interior,
wherein the container apparatus is structured to move between a CLOSED position corresponding to the lid covering the opening, and an OPENED position wherein the lid does not cover the opening, and
wherein, when the container apparatus moves from the CLOSED position toward the OPENED position, the distal portion initially moves toward the interior.

2A. The container apparatus according to embodiment 1A, wherein the lid comprises an elongated member, and a body portion having a first end and a second end disposed opposite and distal the first end; wherein the first end is disposed at the hinge; wherein the elongated member extends outwardly from the second end; and wherein the elongated member is structured to cooperate with the trigger member when the container apparatus moves from the CLOSED position to the OPENED position.

3A. The container apparatus according to embodiment 1A or 2A, optionally embodiment 2A, wherein the body further has a protrusion extending outwardly from a top portion of the sidewall; wherein the protrusion has an aperture; and wherein, when the container apparatus is in the CLOSED position, the elongated member extends into the aperture and interlocks with the protrusion in order to maintain the container apparatus in the CLOSED position.

4A. The container apparatus according to any of embodiments 1A to 3A, optionally embodiment 3A, wherein, when the container apparatus moves from the CLOSED position to the OPENED position, the elongated member initially moves toward the interior, thereby allowing the trigger member to open the lid.

5A. The container apparatus according to any of embodiments 1A to 4A, optionally embodiment 3A or 4A, wherein the sidewall has a second top portion disposed opposite and distal the top portion; and wherein the second top portion is disposed at the hinge.

6A. The container apparatus according to any of embodiments 1A to 5A, wherein the trigger member is integral with the hinge; and wherein the container apparatus is a single unitary component made from a single piece of material.

7A. The container apparatus according to any of embodiments 1A to 6A, optionally embodiment 1A, wherein the trigger member comprises a gripping portion and a latching portion extending from the gripping portion; wherein the gripping portion has the distal portion; and wherein the sidewall is disposed internal with respect to, and is separately coupled to, the latching portion.

8A. The container apparatus according to any of embodiments 1A to 7A, optionally embodiment 7A, wherein the trigger member further comprises a hook portion extending outwardly from the latching portion; wherein the lid comprises a body portion having a first end and a second end disposed opposite and distal the first end; wherein the first end is disposed at the hinge; wherein the second end of the lid has a grooved region; and wherein, when the container apparatus is in the CLOSED position, the hook portion extends into the grooved region in order to maintain the container apparatus in the CLOSED position.

9A. The container apparatus according to any of embodiments 1A to 8A, optionally embodiments 7A or 8A, wherein the latching portion comprises a first end and a second end disposed opposite and distal the first end of the latching portion; wherein the gripping portion comprises a first element and a second element; wherein the first element extends from the first end of the latching portion away from a top portion of the sidewall; wherein the second element extends from the first element toward the top portion; and wherein the second element engages the sidewall in order to bias the second end of the latching portion toward engagement with the sidewall.

10A. The container apparatus according to any of embodiments 1A to 9A, optionally embodiments 7A to 9A, wherein the sidewall has an annular-shaped grooved region; and wherein the latching portion of the trigger member is disposed in the annular-shaped grooved region.

11A. The container apparatus according to any of embodiments 1A to 10A, optionally embodiment 10A, wherein the latching portion comprises a ring-shaped portion and a number of protrusions extending radially inwardly therefrom; and wherein each of the protrusions of the latching portion engages the grooved region in order to maintain the trigger member on the body.

12A. The container apparatus according to any of embodiments 1A to 11A, optionally embodiments 7A to 11A, wherein the latching portion comprises a ring-shaped portion having a grooved region; wherein the body further has a protrusion extending outwardly from the sidewall; wherein the protrusion is disposed proximate the hinge; and wherein, when the container apparatus moves from the CLOSED position toward the OPENED position, the grooved region moves toward the body until the protrusion extends into and engages the grooved region, thereby preventing rotational movement of the ring-shaped portion with respect to the body.

1B. A method of opening a container comprising the steps of:
providing the container with a body and a lid, the body having a base and a sidewall extending therefrom, the body defining an interior comprising a product space configured for housing at least one product, the body further having an opening leading to the interior, the lid being configured to be attached to the sidewall via a hinge;
providing the sidewall with a top portion and a number of latching members extending therefrom;
providing the lid with a body portion and a number of latching members extending therefrom, each of the latching members of the lid being interlocked with a corresponding one of the latching members of the sidewall, the body portion of the lid having a number of thru holes each proximate a corresponding one of the latching members of the lid;
providing a tool comprising a gripping portion and a number of protrusions extending therefrom;
inserting each of the number of protrusions of the tool through a corresponding one of the thru holes in order to release the latching members of the lid from the latching members of the sidewall; and
pivoting the tool about the hinge in order to open the container.

2B. The method according to embodiment 1B, wherein the inserting step further comprises: deflecting each of the latching members of the sidewall inwardly toward the interior.

3B. The method according to embodiment 1B or 2B, wherein the base is disposed in a plane; wherein the number of protrusions comprises a first protrusion, a second protrusion, and a third protrusion; and wherein the inserting step further comprises:

inserting the first protrusion and the second protrusion in a direction toward the base while the third protrusion is inserted in a direction parallel to the plane of the base.

4B. The method according to any of embodiments 1B to 3B, wherein the gripping portion comprises a ribbed portion.

1C. A container apparatus comprising:
a body having a base and a sidewall extending therefrom, the body defining an interior comprising a product space configured for housing at least one product, the body further having an opening leading to the interior;
a lid configured to be attached to the sidewall via a hinge, the lid being structured to move between a CLOSED position corresponding to the lid covering the opening and an OPENED position wherein the lid does not cover the opening; and
a member comprising a coupling portion and a securing portion connected to the coupling potion, the coupling portion being coupled to the sidewall, the member being structured to move between a FIRST position corresponding to the securing portion engaging the lid in order to maintain the lid in the CLOSED position, and a SECOND position wherein the securing portion does not engage the lid,
wherein, when the member moves from the FIRST position toward the SECOND position, the securing portion revolves around a top portion of the sidewall in order to allow the lid to move from the CLOSED position to the OPENED position.

2C. The container apparatus according to embodiment 1C, wherein the member further comprises a number of connecting elements connecting the coupling portion to the securing portion.

3C. The container apparatus according to embodiment 1C or 2C, wherein, when the member moves from the FIRST position toward the SECOND position, the coupling portion remains fixed with respect to the sidewall.

4C. The container apparatus according to any of embodiments 1C to 3C, wherein the coupling portion is annular-shaped; and wherein the sidewall is disposed internal with respect to the coupling portion.

5C. The container apparatus according to any of embodiments 1C to 4C, wherein the body further comprises a number of protrusions extending from the sidewall away from the interior; and wherein the coupling portion engages each of the protrusions in order to prevent longitudinal movement of the coupling portion with respect to the sidewall.

6C. The container apparatus according to any of embodiments 1C to 5C, wherein the sidewall has a number of elongated grooved regions extending from the base toward the lid; wherein the coupling portion comprises a ring-shaped portion and a number of protrusions extending inwardly therefrom; and wherein each of the protrusions of the coupling portion is disposed in a corresponding one of the grooved regions of the sidewall in order to prevent rotational movement of the coupling portion with respect to the sidewall.

7C. The container apparatus according to any of embodiments 1C to 6C, wherein the securing portion comprises a cylindrical-shaped portion and at least one lip extending inwardly from the cylindrical-shaped portion; and wherein, when the member is in the FIRST position, the at least one lip engages the lid in order to maintain the lid in the CLOSED position.

8C. The container apparatus according to any of embodiments 1C to 7C, optionally embodiment 7C, wherein the lid comprises a cover portion and a gripping portion extending outwardly from the cover portion; wherein the at least one lip has a first grooved region and a second grooved region; and wherein, when the member moves from the FIRST position toward the SECOND position, the first grooved region and the second grooved region rotate until the gripping portion and the hinge fit within the first grooved region and the second grooved region, respectively, in order to allow the lid to move from the CLOSED position toward the OPENED position.

9C. The container apparatus according to any of embodiments 1C to 8C, wherein, when the member moves from the FIRST position toward the SECOND position, the securing portion moves toward the coupling portion.

1D. A container apparatus comprising:
a body having a base, a sidewall extending from the base, and a member, the body defining an interior comprising a product space configured for housing at least one product, the body further having an opening leading to the interior, the member being disposed opposite the base and extending from the sidewall away from the interior; and
a lid configured to be attached to the sidewall via a hinge, the lid comprising a cover portion structured to cover the opening, a protrusion extending outwardly from the cover portion, and a component connected to the cover portion, the lid being structured to move between a FIRST position corresponding to the cover portion covering the opening, and a SECOND position wherein the cover portion does not cover the opening,
wherein, when the lid is in the FIRST position, the protrusion engages the member in order to maintain the lid in the FIRST position, and
wherein, when the lid moves from the FIRST position toward the SECOND position, the component moves into engagement with the member in order to disengage the protrusion from the member.

2D. The container apparatus according to embodiment 1D, wherein the lid further comprises a hinge, optionally a living hinge for connecting the component to the cover portion.

3D. The container apparatus according to embodiment 1D or 2D, wherein the container apparatus is a unitary element made from a single piece of material.

4D. The container apparatus according to any of embodiments 1D to 3D, wherein the body has a grooved region extending from the sidewall and the member; wherein, when the lid is in the FIRST position, the protrusion extends into the grooved region.

5D. The container apparatus according to any of embodiments 1D to 4D, optionally embodiment 4D, wherein, when the lid moves from the FIRST position toward the SECOND position, the component causes the member to pivot about the grooved region, thereby allowing the protrusion to move out of the grooved region.

6D. The container apparatus according to any of embodiments 1D to 5D, wherein the cover portion has a thru hole; and wherein, when the lid moves from the FIRST position toward the SECOND position, the component extends through the thru hole in order to move into engagement with the member.

7D. The container apparatus according to any of embodiments 1D to 6D, wherein the component comprises a first portion and a second portion; wherein the first portion is connected to the cover portion; wherein, when the lid is in the FIRST position, the second portion is disposed proximate the hinge; and wherein, when the lid is in the FIRST position, the second portion extends from the first portion away from the base.

8D. The container apparatus according to any of embodiments 1D to 7D, optionally embodiment 7D, wherein the hinge is disposed opposite the member; wherein, when the lid moves from the FIRST position toward the SECOND position, the second portion of the component moves into engagement with the member in order to disengage the protrusion from the member.

9D. The container apparatus according to any of embodiments 1D to 8D, optionally embodiment 7D or 8D, wherein the first portion is pivotably connected to the cover portion by a hinge, optionally a living hinge.

1E. A zipper member for a container apparatus, the container apparatus comprising a bag having a first end portion and a second end portion, the bag being structured to move between a FIRST position corresponding to the first end portion being interlocked with the second end portion, and a SECOND position corresponding to the first end portion being spaced from the second end portion, the zipper member comprising:
a body structured to be coupled to the first end portion and the second end portion;
a pair of opposing arms extending from the body, the pair of opposing arms being structured to move between a THIRD position corresponding to disengagement with the first end portion and the second end portion, and a FOURTH position corresponding to engagement with the first end portion and the second end portion; and
a hood extending from the body, the hood being structured to move between a FIFTH position corresponding to disengagement with the pair of opposing arms, and a SIXTH position corresponding to engagement with the pair of opposing arms,
wherein, when the hood is in the SIXTH position, the hood extends between the pair of opposing arms in order to maintain the pair of opposing arms in the THIRD position.

2E. The zipper member according to embodiment 1E, wherein each of the pair of opposing arms has a grooved region; wherein the hood comprises an elongated member and a pair of protrusions each extending outwardly from the elongated member; and wherein, when the hood is in the SIXTH position, each of the protrusions is disposed in a corresponding grooved region of the pair of opposing arms.

3E. The zipper member according to embodiment 1E or 2E, wherein, when the pair of opposing arms move from the THIRD position toward the FOURTH position, the pair of opposing arms move toward each other.

4E. The zipper member according to embodiments 1E to 3E, wherein each of the pair of opposing arms comprises a corresponding inwardly protruding plow member; and wherein, when each of the pair of opposing arms moves from the THIRD position to the FOURTH position, the plow members are structured to move into engagement with a corresponding one of the first end portion and the second end portion of the bag.

While the invention has been described in detail and with reference to specific examples thereof, it will be apparent to one skilled in the art that various changes and modifications can be made therein without departing from the spirit and scope thereof.

What is claimed is:

1. A container apparatus comprising:
a body having a base, a sidewall extending from the base, and a member, the body defining an interior comprising a product space configured for housing at least one product, the body further having an opening leading to the interior, the member being disposed opposite the base and extending from the sidewall away from the interior; and
a lid configured to be attached to the sidewall via a first hinge, the lid comprising a cover portion structured to cover the opening, a protrusion extending outwardly from the cover portion, and a component connected to the cover portion, the lid being structured to move between a FIRST position corresponding to the cover portion covering the opening, and a SECOND position wherein the cover portion does not cover the opening,
wherein, when the lid is in the FIRST position, the protrusion engages the member in order to maintain the lid in the FIRST position, and
wherein, when the lid moves from the FIRST position toward the SECOND position, the component moves into engagement with the member in order to disengage the protrusion from the member.

2. The container apparatus according to claim 1, wherein the lid further comprises a second hinge for connecting the component to the cover portion.

3. The container apparatus according to claim 1, wherein the container apparatus is a unitary element made from a single piece of material.

4. The container apparatus according to claim 1, wherein the body has a grooved region extending from the sidewall and the member; wherein, when the lid is in the FIRST position, the protrusion extends into the grooved region.

5. The container apparatus according to claim 4, wherein, when the lid moves from the FIRST position toward the SECOND position, the component causes the member to pivot about the grooved region, thereby allowing the protrusion to move out of the grooved region.

6. The container apparatus according to claim 1, wherein the cover portion has a thru hole; and wherein, when the lid moves from the FIRST position toward the SECOND position, the component extends through the thru hole in order to move into engagement with the member.

7. The container apparatus according to claim 1, wherein the component comprises a first portion and a second portion; wherein the first portion is connected to the cover portion; wherein, when the lid is in the FIRST position, the second portion is disposed proximate the first hinge; and wherein, when the lid is in the FIRST position, the second portion extends from the first portion away from the base.

8. The container apparatus according to claim 7, wherein the first hinge is disposed opposite the member; wherein, when the lid moves from the FIRST position toward the SECOND position, the second portion of the component moves into engagement with the member in order to disengage the protrusion from the member.

9. The container apparatus according to claim 7, wherein the first portion is pivotably connected to the cover portion by a second hinge.

10. A zipper member for a container apparatus, the container apparatus comprising a bag having a first end portion and a second end portion, the bag being structured to move between a FIRST position corresponding to the first end portion being interlocked with the second end portion, and a SECOND position corresponding to the first end portion being spaced from the second end portion, the zipper member comprising:
a body structured to be coupled to the first end portion and the second end portion;
a pair of opposing arms extending from the body, the pair of opposing arms being structured to move between a THIRD position corresponding to disengagement with the first end portion and the second end portion, and a FOURTH position corresponding to engagement with the first end portion and the second end portion; and
a hood extending from the body, the hood being structured to move between a FIFTH position corresponding to disengagement with the pair of opposing arms, and a SIXTH position corresponding to engagement with the pair of opposing arms,
wherein, when the hood is in the SIXTH position, the hood extends between the pair of opposing arms in order to maintain the pair of opposing arms in the THIRD position.

11. The zipper member according to claim 10, wherein each of the pair of opposing arms has a grooved region; wherein the hood comprises an elongated member and a pair of protrusions each extending outwardly from the elongated member; and wherein, when the hood is in the SIXTH position, each of the protrusions is disposed in a corresponding grooved region of the pair of opposing arms.

12. The zipper member according to claim 10, wherein, when the pair of opposing arms move from the THIRD position toward the FOURTH position, the pair of opposing arms move toward each other.

13. The zipper member according to claim 10, wherein each of the pair of opposing arms comprises a corresponding inwardly protruding plow member; and wherein, when each of the pair of opposing arms moves from the THIRD position to the FOURTH position, the plow members are structured to move into engagement with a corresponding one of the first end portion and the second end portion of the bag.

14. A container apparatus comprising the bag and the zipper member according to claim 10, wherein the zipper member is coupled to the first end portion and the second end portion of the bag.

15. A container apparatus comprising:
a body having a base and a sidewall extending therefrom, the body defining an interior comprising a product space configured for housing at least one product, the body further having an opening leading to the interior;
a lid configured to be attached to the sidewall via a hinge; and
a trigger member connected to or integral with the hinge, the trigger member having a distal portion disposed opposite the hinge and external with respect to the interior,
wherein the container apparatus is structured to move between a CLOSED position corresponding to the lid covering the opening, and an OPENED position wherein the lid does not cover the opening, and
wherein, when the container apparatus moves from the CLOSED position toward the OPENED position, the distal portion initially moves toward the interior.

16. The container apparatus according to claim 15, wherein the lid comprises an elongated member, and a body portion having a first end and a second end disposed opposite and distal the first end; wherein the first end is disposed at the hinge; wherein the elongated member extends outwardly from the second end; and wherein the elongated member is structured to cooperate with the trigger member when the container apparatus moves from the CLOSED position to the OPENED position.

17. The container apparatus according to claim 16, wherein the body further has a protrusion extending outwardly from a top portion of the sidewall; wherein the protrusion has an aperture; and wherein, when the container apparatus is in the CLOSED position, the elongated member extends into the aperture and interlocks with the protrusion in order to maintain the container apparatus in the CLOSED position.

18. The container apparatus according to claim 17, wherein, when the container apparatus moves from the CLOSED position to the OPENED position, the elongated member initially moves toward the interior, thereby allowing the trigger member to open the lid.

19. The container apparatus according to claim 17, wherein the sidewall has a second top portion disposed opposite and distal the top portion; and wherein the second top portion is disposed at the hinge.

20. The container apparatus according to claim 15, wherein the trigger member is integral with the hinge; and wherein the container apparatus is a single unitary component made from a single piece of material.

21. The container apparatus according to claim 15, wherein the trigger member comprises a gripping portion and a latching portion extending from the gripping portion; wherein the gripping portion has the distal portion; and wherein the sidewall is disposed internal with respect to, and is separately coupled to, the latching portion.

22. The container apparatus according to claim 21, wherein the trigger member further comprises a hook portion extending outwardly from the latching portion; wherein the lid comprises a body portion having a first end and a second end disposed opposite and distal the first end; wherein the first end is disposed at the hinge; wherein the second end of the lid has a grooved region; and wherein, when the container apparatus is in the CLOSED position, the hook portion extends into the grooved region in order to maintain the container apparatus in the CLOSED position.

23. The container apparatus according to claim 21, wherein the latching portion comprises a first end and a second end disposed opposite and distal the first end of the latching portion; wherein the gripping portion comprises a first element and a second element; wherein the first element extends from the first end of the latching portion away from a top portion of the sidewall; wherein the second element extends from the first element toward the top portion; and wherein the second element engages the sidewall in order to bias the second end of the latching portion toward engagement with the sidewall.

24. The container apparatus according to claim 21, wherein the sidewall has an annular-shaped grooved region; and wherein the latching portion of the trigger member is disposed in the annular-shaped grooved region.

25. The container apparatus according to claim 24, wherein the latching portion comprises a ring-shaped portion and a number of protrusions extending radially inwardly therefrom; and wherein each of the protrusions of the latching portion engages the grooved region in order to maintain the trigger member on the body.

26. The container apparatus according to claim 21, wherein the latching portion comprises a ring-shaped portion having a grooved region; wherein the body further has a protrusion extending outwardly from the sidewall; wherein the protrusion is disposed proximate the hinge; and wherein, when the container apparatus moves from the CLOSED position toward the OPENED position, the grooved region moves toward the body until the protrusion extends into and engages the grooved region, thereby preventing rotational movement of the ring-shaped portion with respect to the body.

27. A method of opening a container comprising the steps of:
providing the container with a body and a lid, the body having a base and a sidewall extending therefrom, the body defining an interior comprising a product space configured for housing at least one product, the body further having an opening leading to the interior, the lid being configured to be attached to the sidewall via a hinge;
providing the sidewall with a top portion and a number of latching members extending therefrom;
providing the lid with a body portion and a number of latching members extending therefrom, each of the latching members of the lid being interlocked with a corresponding one of the latching members of the sidewall, the body portion of the lid having a number of thru holes each proximate a corresponding one of the latching members of the lid;
providing a tool comprising a gripping portion and a number of protrusions extending therefrom;
inserting each of the number of protrusions of the tool through a corresponding one of the thru holes in order to release the latching members of the lid from the latching members of the sidewall; and
pivoting the tool about the hinge in order to open the container.

28. The method according to claim 27, wherein the inserting step further comprises: deflecting each of the latching members of the sidewall inwardly toward the interior.

29. The method according to claim 27, wherein the base is disposed in a plane; wherein the number of protrusions comprises a first protrusion, a second protrusion, and a third protrusion; and wherein the inserting step further comprises: inserting the first protrusion and the second protrusion in a direction toward the base while the third protrusion is inserted in a direction parallel to the plane of the base.

30. The method according to claim 27, wherein the gripping portion comprises a ribbed portion.

31. A container apparatus comprising:
a body having a base and a sidewall extending therefrom, the body defining an interior comprising a product space configured for housing at least one product, the body further having an opening leading to the interior;
a lid configured to be attached to the sidewall via a hinge, the lid being structured to move between a CLOSED position corresponding to the lid covering the opening and an OPENED position wherein the lid does not cover the opening; and
a member comprising a coupling portion and a securing portion connected to the coupling potion, the coupling portion being coupled to the sidewall, the member being structured to move between a FIRST position corresponding to the securing portion engaging the lid in order to maintain the lid in the CLOSED position, and a SECOND position wherein the securing portion does not engage the lid,
wherein, when the member moves from the FIRST position toward the SECOND position, the securing portion revolves around a top portion of the sidewall in order to allow the lid to move from the CLOSED position to the OPENED position.

32. The container apparatus according to claim 31, wherein the member further comprises a number of connecting elements connecting the coupling portion to the securing portion.

33. The container apparatus according to claim 31, wherein, when the member moves from the FIRST position toward the SECOND position, the coupling portion remains fixed with respect to the sidewall.

34. The container apparatus according to claim 31, wherein the coupling portion is annular-shaped; and wherein the sidewall is disposed internal with respect to the coupling portion.

35. The container apparatus according to claim 31, wherein the body further comprises a number of protrusions extending from the sidewall away from the interior; and wherein the coupling portion engages each of the protrusions in order to prevent longitudinal movement of the coupling portion with respect to the sidewall.

36. The container apparatus according to claim 31, wherein the sidewall has a number of elongated grooved regions extending from the base toward the lid; wherein the coupling portion comprises a ring-shaped portion and a number of protrusions extending inwardly therefrom; and wherein each of the protrusions of the coupling portion is disposed in a corresponding one of the grooved regions of the sidewall in order to prevent rotational movement of the coupling portion with respect to the sidewall.

37. The container apparatus according to claim 31, wherein the securing portion comprises a cylindrical-shaped portion and at least one lip extending inwardly from the cylindrical-shaped portion; and wherein, when the member is in the FIRST position, the at least one lip engages the lid in order to maintain the lid in the CLOSED position.

38. The container apparatus according to claim 37, wherein the lid comprises a cover portion and a gripping portion extending outwardly from the cover portion; wherein the at least one lip has a first grooved region and a second grooved region; and wherein, when the member moves from the FIRST position toward the SECOND position, the first grooved region and the second grooved region rotate until the gripping portion and the hinge fit within the first grooved region and the second grooved region, respectively, in order to allow the lid to move from the CLOSED position toward the OPENED position.

39. The container apparatus according to claim 31, wherein, when the member moves from the FIRST position toward the SECOND position, the securing portion moves toward the coupling portion.
